(19) United States
(12) Patent Application Publication
(10) Pub. No.: US 2017/0342997 A1
(43) Pub. Date: Nov. 30, 2017

(54) COMPRESSOR AND TURBOCHARGER

(71) Applicant: Cummins Ltd., Huddersfield (GB)

(72) Inventor: James Donaldson, West Yorkshire (GB)

(73) Assignee: Cummins Ltd., Huddersfield (GB)

(21) Appl. No.: 15/524,918

(22) PCT Filed: Nov. 6, 2015
(86) PCT No.: PCT/GB2015/053378

§ 371 Date: May 5, 2017

(30) Foreign Application Priority Data
Nov. 7, 2014 (GB) 1419831.1

(51) Int. Cl. F04D 27/02; F04D 29/46; F04D 29/24

(52) U.S. Cl. CPC F04D 27/0246; F05D 2220/40; F04D 29/24; F04D 29/462

(57) ABSTRACT

A compressor comprising a housing having an axial intake defining an intake passage and an annular outlet volute defining an annular outlet volute passage, an impeller mounted on a shaft for rotation about a shaft axis between the axial intake and the annular outlet volute, the impeller having a plurality of blades, a diffuser defining an annular diffuser passage surrounding the impeller, the annular diffuser passage having a diffuser inlet downstream of said plurality of blades, the tips of the blades sweeping across said diffuser inlet during use, wherein the compressor further comprises at least two vane members, each having a vane receivable in the diffuser passage and an actuator is coupled to the vane members to move each such that the axial length of it's vane within the diffuser passage is varied.

### RELATED APPLICATIONS

This application is a national phase filing under 35 U.S.C. §371 of International Application No. PCT/GB2015/053378, titled “COMPRESSOR AND TURBOCHARGER,” filed on Nov. 6, 2015, which claims the benefit of priority to British Patent Application No. 1419831.1, filed with the United Kingdom Intellectual Property Office on Nov. 7, 2014, the entire disclosures of which being expressly incorporated herein by reference.

### FIELD OF THE DISCLOSURE

The present disclosure relates to a compressor. In particular, the present disclosure relates to a centrifugal compressor such as, for example, the centrifugal compressor of a turbocharger.

### BACKGROUND

A compressor comprises an impeller, carrying a plurality of blades mounted on a shaft for rotation within a compressor housing. Rotation of the impeller causes gas (e.g. air) to be drawn into the impeller and delivered to an outlet chamber or passage. In the case of a centrifugal compressor the outlet passage is in the form of a volute defined by the compressor housing around the impeller. Gas flows through the impeller to the outlet volute via an annular passage referred to as the diffuser. The diffuser has an upstream annular inlet surrounding the impeller and a downstream annular outlet opening into the volute.

Turbochargers are well known devices for supplying air to the intake of an internal combustion engine at pressures above atmospheric pressure (boost pressures). A conventional turbocharger essentially comprises a housing in which is provided an exhaust gas driven turbine wheel mounted on a rotatable shaft connected downstream of an engine outlet manifold. A compressor impeller wheel is mounted on the opposite end of the shaft such that rotation of the turbine wheel drives rotation of the impeller wheel. In this application of a compressor, the impeller wheel delivers compressed air to the engine intake manifold. The turbocharger shaft is conventionally supported by journal and thrust bearings, including appropriate lubricating systems.

In known turbochargers, the turbine stage comprises a turbine chamber within which the turbine wheel is mounted; an annular inlet passage defined between facing radial walls arranged around the turbine chamber; an inlet arranged around the inlet passage; and an outlet passage extending from the turbine chamber. The passages and chambers communicate such that pressurised exhaust emissions, including gaseous and particulate species, admitted to the inlet chamber flow through the inlet passage to the outlet passage via the turbine and rotate the turbine wheel. It is also known to improve turbine performance by providing vanes, referred to as nozzle vanes, in the inlet passage so as to deflect gas flowing through the inlet passage towards the direction of rotation of the turbine wheel. Turbines may be of a fixed or variable geometry type. Variable geometry turbines differ from fixed geometry turbines in that the size of the inlet passage can be varied to optimise gas flow velocities over a range of mass flow rates so that the power output of the turbine can be varied to suit varying engine demands. For instance, when the volume of exhaust gas being delivered to the turbine is relatively low, the velocity of the gas reaching the turbine wheel is maintained at a level which ensures efficient turbine operation by reducing the size of the annular inlet passage.

In some turbochargers the compressor inlet has a structure that has become known as a “map width enhanced (MWE)” structure. An MWE structure is described for instance in U.S. Pat. No. 4,743,161. The inlet of such an MWE compressor comprises two coaxial tubular inlet sections, an outer inlet section forming the compressor intake and an inner inlet section defining the compressor inducer, or main inlet. The inner inlet section is shorter than the outer inlet section and has an inner surface which is an extension of a surface of an inner wall of the compressor housing which is swept by the curved edges of the impeller blades. An annular flow passage is defined between the two tubular inlet sections which is open at its upstream end (relative to the intake) and is provided with apertures at its downstream end (relative to the intake) which communicate with the inner surface of the compressor housing which faces the impeller.

In operation the pressure within the annular flow passage surrounding the compressor inducer is normally lower than atmospheric pressure. During high gas flow and high speed operation of the impeller the pressure in the area swept by the impeller is less than that in the annular passage. Thus, under such conditions air flows inward from the annular passage to the impeller wheel thereby increasing the amount of air reaching the impeller wheel, and increasing the maximum flow capacity (choke limit) of the compressor.

However, as the flow through the impeller drops, or as the speed of the impeller drops, so the amount of air drawn into the impeller through the annular passage decreases until the pressure reaches equilibrium. A further drop in the impeller gas flow or speed results in the pressure in the area swept by the impeller wheel increasing above that within the annular passage so that there is a reversal in the direction of air flow through the annular passage. That is, under such conditions air flows outward from the impeller to the upstream end of the annular passage and is returned to the compressor intake for re-circulation.

Increasing gas flow through the impeller, or impeller speed, causes the reverse to happen, i.e. a decrease in the amount of air returned to the intake through the annular passage, followed by equilibrium, in turn followed by reversal of the air flow through the annular passage so that air is drawn into the impeller wheel via the apertures communicating between the annular passage and the impeller.

It is well known that this MWE arrangement stabilises the performance of the compressor increasing the maximum flow capacity and improving the surge margin, i.e. decreasing the flow at which the compressor surges over a range of compressor speeds. Since both the maximum flow capacity (choke flow) and surge margin are improved the width of the compressor map increases. Hence the term “map width enhanced” compressor.

It is known to provide compressors with fixed vanes located in the diffuser passage of the compressor in order to provide a compressor efficiency gain at a certain running point of the compressor (e.g. speed of the impeller). However, these vanes only provide an efficiency gain at a single running point of the compressor and generally provide detrimental performance at all other running points.

In order to try and address this problem, it is also known to provide vanes in the diffuser passage that can have their angle adjusted relative to the longitudinal axis of the compressor. Such diffusers are generally known as ‘Swing Vane Diffusers’ (SVDs). However, Swing Vane Diffusers require a relatively large number of moving parts, which increases the likelihood of failure, as well as cost.

It is also known to provide a single set of vanes that is axially movable relative to the diffuser passage between a first position in which the vanes extend axially across the diffuser passage and a second position in which the vanes are disposed axially outboard of the diffuser passage. Such diffusers are generally known as ‘Variable Vane Diffusers’ (VVDs). A Variable Vane Diffuser is more durable than a SVD. However VVDs only provide an efficiency gain at a single running point of the compressor and generally provide detrimental performance at all other running points. Therefore, to provide acceptable efficiency at the other running points it is generally necessary to move the set of vanes to the second (retracted position), thereby making the diffuser vaneless.

### SUMMARY

It is an object of the present disclosure to obviate or mitigate one or more of the problems set out above.

A further object of the present disclosure is to provide an improved or alternative compressor.

According to a first aspect of the present disclosure there is provided a compressor comprising:

a housing having an axial intake defining an intake passage and an annular outlet volute defining an outlet volute passage;

an impeller mounted on a shaft for rotation about a shaft axis between the axial intake and the outlet volute;

the impeller having a plurality of blades;

a diffuser defining an annular diffuser passage surrounding the impeller;

said annular diffuser passage having a diffuser inlet downstream of said plurality of blades, the tips of the blades sweeping across said diffuser inlet during use, and a diffuser outlet communicating with the outlet volute passage;

the diffuser passage being defined by opposed first and second radially extending surfaces;

wherein the compressor further comprises at least two vane members, each vane member having at least one vane arranged to be receivable in the diffuser passage;

and wherein at least one actuator is coupled to the at least two vane members so as to move each vane member such that the axial length of it's at least one vane within the diffuser passage is varied.

This is advantageous in that it allows the overall configuration of the vanes within the diffuser passage to be adjusted. This allows the configuration of the vanes to be adjusted to provide efficiency gains at different operating points of the compressor.

2. It will be appreciated that references to radially extending or axially extending surfaces include where the surfaces are substantially parallel to the radial or axial directions respectively, but do not specifically require this. Such references require that the surfaces extend generally in the radial or axial directions, i.e. they extend in a direction that has at least a component in the radial or axial directions respectively.

References to the axial length of the at least one vane of each vane member refers to the length of the at least one vane in the direction of said shaft axis.

Each vane member may be movable relative to the diffuser passage between a first position and a second position, wherein when the vane member is in the first position, at least an axial length of it's at least one vane is located within the diffuser passage and when the vane member is in the second position, it's at least one vane is not located within the diffuser passage.

When each vane member is in the first position, it's at least one vane may extend substantially across the axial extent of the diffuser passage. Optionally the at least one vane of each vane member extends axially from a root, at a surface of an annular wall of the vane member, to a tip and when each vane member is in the first position, the tip of its at least one vane abuts a radially extending surface of the diffuser passage.

Optionally the at least one vane of each vane member extends axially from a root, at a surface of an annular wall of the vane member, to a tip and when the vane member is in the second position, the tip of its at least one vane is disposed axially outboard of the diffuser passage. It will be appreciated that, in this case, when each vane member is in the second position, the axial length of it's at least one vane that is located within the diffuser passage is substantially zero.

The at least two vane members may be three or more said vane members. The at least two vane members may be four or more said vane members.

The at least one actuator may be coupled to each vane member such that the vane members are movable to a configuration in which at least one vane member is in the first position and at least one vane member is in the second position. The at least one actuator may be coupled to each vane member such that the vane members are movable to a configuration in which at least one vane member is in the first position and a plurality of vane members are in the second position. The at least one actuator may be coupled to each vane member such that the vane members are movable to a configuration in which a plurality of vane members are in the first position and at least one vane member is in the second position. The at least one actuator may be coupled to each vane member such that the vane members are movable to a configuration in which a plurality of vane members are in the first position and a plurality of vane members are in the second position.

The at least one actuator may be coupled to each vane member such that the vane members are movable to a configuration in which all of the vane members are in the first position. The at least one actuator may be coupled to each vane member such that the vane members are movable to a configuration in which all of the vane members are in the second position.

Optionally, a first of the vane members is mounted on a first axial side of the diffuser passage and a second of the vane members is mounted on a second axial side of the diffuser passage.

In this case, when the first and second vane members are each in the second position, they are located on the first and second axial sides of the diffuser passage respectively.

Optionally, first and second of said vane members are mounted on the same axial side of the diffuser passage. In this case, when the first and second vane members are each in the second position, they are each located on the same axial side of the diffuser passage.

A plurality of the vane members may be mounted on the first and/or second axial sides of the diffuser passage.

One or more of the vane members may comprise a plurality of vanes. The plurality of vanes may be distributed in a circumferential direction about an annular wall of the vane member.

The first and second radially extending surfaces of the diffuser passage may be defined by a radially extending surface of a first and second wall member respectively, wherein at least one of the vane members is slidably mounted in a cavity on an axially outboard side of the first or second wall member, said first or second wall member being provided with at least one vane slot arranged such that as the at least one vane member is moved in the axial direction, it's at least one vane is receivable in the diffuser passage, through the at least one vane slot.

Where the at least one vane member comprises a plurality of vanes, said first or second wall member may be provided with a plurality of vane slots arranged such that as the at least one vane member is moved in the axial direction, each vane is receivable in the diffuser passage, through a respective vane slot.

Optionally, the at least one actuator is coupled to first and second of said vane members such that the first and second vane members are moved axially relative to each other. The vanes of the first and second vane members may be circumferentially spaced such that when the first and second vane members are moved axially relative to each other, their vanes pass each other in the axial direction.

One of the first and second vane members may be provided with at least one slot to receive the at least one vane of the other of the first and second vane members, so as to allow relative axial movement between the vane members. One of the first and second vane members may be provided with a plurality of slots to receive the plurality of vanes of the other of the first and second vane members, so as to allow relative axial movement between the vane members.

The first and second vane members may each be provided with a plurality of radially extending webs, wherein each vane of the vane member is mounted on a respective web and wherein the webs and vanes of each vane member are arranged such that when the vane members move axially relative to each other, the radially extending webs and vanes of one of the vane members are received between the radially extending webs and vanes of the other vane member so as to allow for relative axial movement between the vane members.

The at least one vane of each vane member may be rotationally fixed relative to the shaft axis. The at least one vane of each vane member may be rotationally fixed relative to an annular wall of the vane member on which the at least one vane is mounted. The two or more vane members may be rotationally fixed relative to the housing.

The at least one vane of a first of the vane members may be shaped and/or oriented differently to the at least one vane of a second of the vane members, such that the performance of the compressor is varied in dependence on the axial positions of the vane members.

The first or second radially extending surface may be a surface of the compressor housing or a surface that forms part of the compressor, for example a surface of a bearing housing.

The at least one actuator may be coupled to the at least two vane members by a cam member, the at least one actuator being arranged to move the cam member relative to the vane members, said cam member comprising at least two cam surfaces, wherein each vane member is provided with, or coupled to, a respective vane member cam surface, said cam surfaces being arranged such that as the cam member is moved relative to the vane members, each of the at least two cam surfaces of the cam member engages a respective vane member cam surface such that the vane member is moved in the axial direction relative to the diffuser passage.

The at least two cam surfaces may each be surfaces of respective protrusions on the cam member, wherein the vane member cam surfaces are surfaces of protrusions on the vane members.

The at least two cam surfaces may each be surfaces of a respective slot, wherein each vane cam member is received within a respective slot and as the cam member is moved relative to the vane members, each vane cam member travels along the respective slot, relative to the slot, wherein the cam surface of the respective slot engages the vane cam member such that the vane member is moved in the axial direction relative to the diffuser passage. In this case, each vane member cam surface may be a surface of a protrusion of the respective vane member.

The cam member may be an annular member, wherein said slots are provided in the annular member. The slots may be distributed in the circumferential direction about the annular member. The annular member may comprise first and second radially extending webs, wherein said slots are provided in one or more of said webs.

The actuator may be arranged to rotate the annular member relative to the vane members.

Optionally the cam surfaces are arranged such that when the cam member is moved from a first position to a second position, one or more vane member is moved from the first position to the second position or vice versa. Optionally the cam surfaces are arranged such that when the cam member is moved from its second position to its first position, one or more vane member is moved from its second position to its first position, or vice versa.

The cam surfaces may be arranged such that when the cam member is moved from a first position to a second position, or vice-versa, at least one of the vane members is not moved relative to the diffuser passage.

The cam surfaces may be arranged such that when the cam member is moved to more than two positions, one or more of the vane members is moved from its first position to its second position, or vice-versa.

The at least two cam surface of the cam member and the vane member cam surfaces may be curved or part-curved. The at least two cam surface of the cam member and the vane member cam surfaces may be any suitable shape, including straight, curved or part-curved. One, or each cam surface may comprise a plurality of sections that are inclined relative to each other.

The at least one actuator may be arranged to move the cam member in an axial direction relative to the vane members. Alternatively, or additionally, the at least one actuator may be arranged to rotate the cam member relative to the vane members.

The at least one actuator may be coupled to the at least two vane members by a rack and pinion arrangement. In this regard, the at least one actuator may be arranged to drivable rotate a toothed pinion and each vane member may be provided with a toothed rack that is engaged with the pinion such that rotation of the pinion moves the rack, and therefore the vane member, in the axial direction relative to the diffuser passage.

The at least one actuator may be a single actuator coupled to each vane member. Alternatively, the at least one actuator be comprise a plurality of actuators, each coupled to different vane member.

According to a second aspect of the disclosure there is provided a turbocharger comprising a compressor according to the first aspect of the disclosure.

According to a third aspect of the disclosure there is provided an internal combustion engine comprising a turbocharger according to the second aspect of the disclosure.

The internal combustion engine may comprise an engine control unit that is arranged to control the axial position of the at least two vane members. The engine control unit may be arranged to control the axial position of the at least two vane members in dependence on an operating condition of the compressor, turbocharger and/or of the internal combustion engine. The engine control unit may be arranged to control the axial position of the at least two vane members in dependence on whether an operating condition of the compressor, turbocharger and/or of the internal combustion engine is substantially constant for a certain period of time. The operating condition may be the speed of the internal combustion engine. Other operating conditions may be used.

According to a fourth aspect of the disclosure there is provided a method of operating a compressor, said compressor comprising:

a housing having an axial intake defining an intake passage and an annular outlet volute defining an outlet volute passage;

an impeller mounted on a shaft for rotation about a shaft axis between the axial intake and the outlet volute;

the impeller having a plurality of blades;

a diffuser defining an annular diffuser passage surrounding the impeller;

said annular diffuser passage having a diffuser inlet downstream of said plurality of blades, the tips of the blades sweeping across said diffuser inlet during use, and a diffuser outlet communicating with the outlet volute passage;

the diffuser passage being defined by opposed first and second radially extending surfaces;

the compressor comprising at least two vane members, each vane member having at least one vane arranged to be receivable in the diffuser passage;

and at least one actuator coupled to the at least two vane members so as to move each vane member in the axial direction;

wherein the method comprises using the at least one actuator to move each vane member such that the axial length of it's at least one vane within the diffuser passage is varied.

Each vane member may be moved relative to the diffuser passage between a first position and a second position, wherein when the vane member is in the first position, at least an axial length of it's at least one vane is located within the diffuser passage and when the vane member is in the second position, it's at least one vane is not located within the diffuser passage.

The vane members may be moved to a configuration in which at least one vane member is in the first position and at least one vane member is in the second position. The vane members may be moved to a configuration in which at least one vane member is in the first position and a plurality of vane members are in the second position. The vane members may be moved to a configuration in which a plurality of vane members are in the first position and at least one vane member is in the second position.

The vane members may be moved to a configuration in which in which all of the vane members are in the first position. The vane members may be moved to a configuration in which all of the vane members are in the second position.

The method may comprise control the axial position of the at least two vane members in dependence on an operating condition of the compressor or turbocharger.

Any of the features of any of the above aspects of the disclosure may be combined with any feature of any of the other aspects of the disclosure.

### BRIEF DESCRIPTION OF THE DRAWINGS

Other advantages and features of the disclosure will be apparent from the following description:

Specific embodiments of the present disclosure will now be described, by way of example only, with reference to the accompanying drawings, in which:

FIG. 1 is an axial cross-section through a known variable geometry turbocharger;

FIG. 2 is an axial cross-section of a known ‘Map Width Enhanced’ (MWE) compressor of a turbocharger, of a slightly different design to that of FIG. 1 and where a retaining ring and noise baffle are omitted for illustrative purposes;

FIG. 3 is an axial cross-sectional view of a portion of a compressor and bearing assembly of a turbocharger comprising a compressor according to a first embodiment of the present disclosure, where first and second vane rings of the compressor are in a first configuration;

FIG. 4 shows an enlarged version of the compressor shown in FIG. 3;

FIG. 5 is a view corresponding to that of FIG. 4, but wherein the first and second vane rings of the compressor are in a second configuration;

FIG. 6 is a perspective view of a circumferential section of first and second vane rings of the compressor shown in FIGS. 3 to 5;

FIG. 7 is a front elevational view of a circumferential section of a first wall member of the compressor shown in FIGS. 3 to 5;

FIG. 8 is an axial cross-sectional view of a portion of a compressor and bearing assembly of a turbocharger comprising a compressor according to a second embodiment of the present disclosure, where the second vane ring is not shown for illustrative purposes;

FIG. 9 is a perspective view of a circumferential section of first and second vane rings of the compressor shown in FIG. 8;

FIG. 10 is a front elevational view of a circumferential section of a first wall member of the compressor shown in FIG. 8;

FIG. 11 shows a modified version of the first embodiment of the disclosure shown in FIGS. 3 to 7, where first, second and third vane rings of the compressor are in a first configuration;

FIG. 12 shows a view corresponding to that of FIG. 11, but where the first, second and third vane rings are in a second configuration;

FIG. 13 shows a view corresponding to that of FIGS. 11 and 12, but wherein the first, second and third vane rings are in a third configuration;

FIG. 14 is an axial cross-sectional view of a portion of a compressor and bearing assembly of a turbocharger comprising a compressor according to a third embodiment of the present disclosure, where first, second and third vane rings of the compressor are in a first configuration;

FIG. 15 shows a perspective view of a portion of a cam ring and pinion wheel of an actuator assembly of the compressor shown in FIG. 14;

FIG. 16 shows an axial perspective view of a portion of an actuator assembly of a slightly different version to that shown in FIG. 14, and first, second and third vane rings;

FIG. 17 is a schematic view of the compressor shown in FIGS. 14 to 16 illustrating the position of the vanes of the first, second and third vane rings relative to the diffuser passage, for a first position of a cam ring, with the vane rings in a first configuration;

FIG. 18 shows a schematic view corresponding to that of FIG. 17, but where the cam ring is in a second position and the vane rings are in a second configuration;

FIG. 19 shows a schematic view corresponding to FIG. 17, but where the cam ring is in a third position and the vane rings are in a third configuration, and

FIG. 20 shows a schematic view corresponding to FIG. 17, but where the cam ring is in a fourth position and the vanes rings are in a fourth configuration.

### DETAILED DESCRIPTION OF THE DRAWINGS

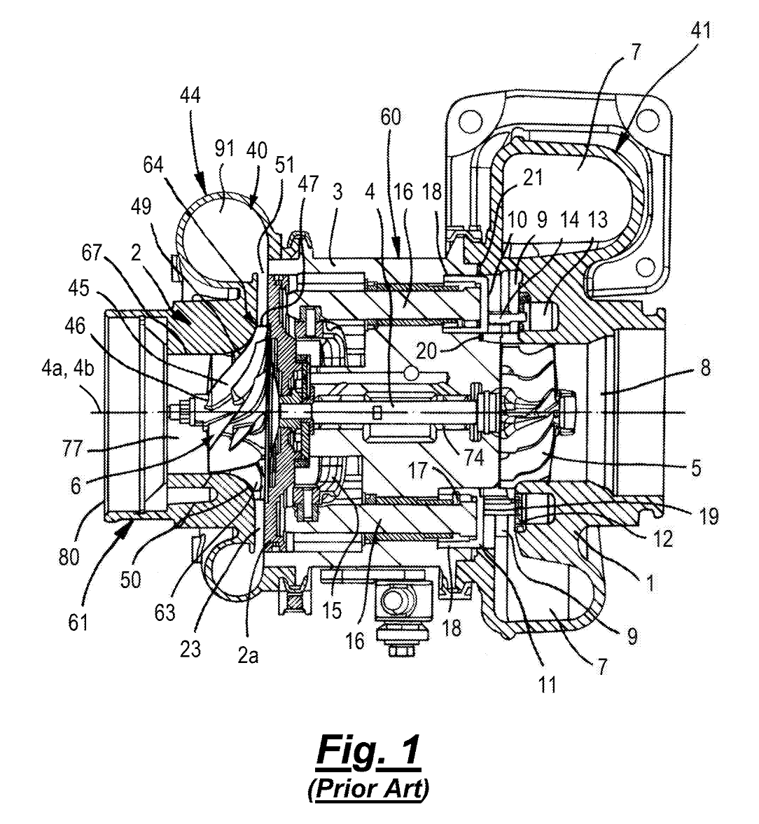

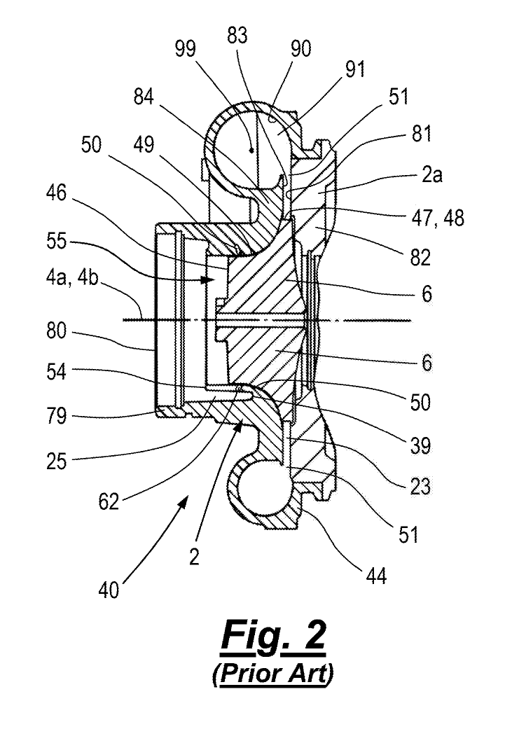

Referring to FIGS. 1 and 2, this illustrates a known variable geometry turbocharger comprising a turbine 41 and a compressor 40 interconnected by a bearing assembly 60 (the compressor shown in FIG. 2 is of slightly different design to that of FIG. 1 and like reference numerals will be used for like features).

The turbine 41 comprises a turbine wheel 5 mounted on one end of a shaft 4 for rotation within a turbine housing 1. The compressor 40 comprises an impeller wheel 6 mounted on the other end of the shaft 4 for rotation within a compressor housing 2. The compressor housing 2 has a central longitudinal axis 4a.

The turbine housing 1 and the compressor housing 2 are interconnected by a central bearing housing 3 of the bearing assembly 60. The turbocharger shaft 4 extends from the turbine housing 1 to the compressor housing 2 through the bearing housing 3. The shaft 4 rotates about an axis 4b that is substantially parallel and co-incident with the longitudinal axis 4a of the compressor housing 2. The shaft 4 is rotatably supported by bearings 74 located in the bearing housing 3.

The turbine housing 1 defines an inlet volute 7 to which gas from an internal combustion engine (not shown) is delivered. The exhaust gas flows from the inlet volute 7 to an axial outlet passage 8 via an annular inlet passage 9 and the turbine wheel 5. The inlet passage 9 is defined on one side by a face 10 of a radial wall of a movable annular wall member 11, commonly referred to as a “nozzle ring”, and on the opposite side by an annular shroud 12 which forms the wall of the inlet passage 9 facing the nozzle ring 11. The shroud 12 covers the opening of an annular recess 13 in the turbine housing 1.

The nozzle ring 11 supports an array of circumferentially and equally spaced inlet vanes 14 each of which extends across the inlet passage 9. The vanes 14 are orientated to deflect gas flowing through the inlet passage 9 towards the direction of rotation of the turbine wheel 5. When the nozzle ring 11 is proximate to the annular shroud 12, the vanes 14 project through suitably configured slots in the shroud 12, into the recess 13.

The position of the nozzle ring 11 is controlled by an actuator assembly of the type disclosed in U.S. Pat. No. 5,868,552. An actuator assembly (not shown) is operable to adjust the position of the nozzle ring 11 via an actuator assembly output shaft (not shown), which is linked to a yoke 15. The yoke 15 in turn engages axially extending actuating rods 16 that support the nozzle ring 11. Accordingly, by appropriate control of the actuator assembly (which may for instance be pneumatic or electric), the axial position of the rods 16 and thus of the nozzle ring 11 can be controlled. The speed of the turbine wheel 5 is dependent upon the velocity of the gas passing through the annular inlet passage 9. For a fixed rate of mass of gas flowing into the inlet passage 9, the gas velocity is a function of the width of the inlet passage 9, the width being adjustable by controlling the axial position of the nozzle ring 11. FIG. 1 shows the annular inlet passage 9 fully open. The inlet passage 9 may be closed to a minimum by moving the face 10 of the nozzle ring 11 towards the shroud 12.

The nozzle ring 11 has axially extending radially inner and outer annular flanges 17 and 18 that extend into an annular cavity 19 provided in the bearing housing 3. Inner and outer sealing rings 20 and 21 are provided to seal the nozzle ring 11 with respect to inner and outer annular surfaces of the annular cavity 19 respectively, whilst allowing the nozzle ring 11 to slide within the annular cavity 19. The inner sealing ring 20 is supported within an annular groove formed in the radially inner annular surface of the cavity 19 and bears against the inner annular flange 17 of the nozzle ring 11. The outer sealing ring 21 is supported within an annular groove formed in the radially outer annular surface of the cavity 19 and bears against the outer annular flange 18 of the nozzle ring 11.

The compressor housing 2 comprises an axial intake 61 that extends axially from an intake port 80 to a chamber 63 in which the impeller wheel 6 is rotatably mounted and a diffuser 64 that defines an annular diffuser passage 23 surrounding the impeller wheel 6 and extends radially outwardly from the impeller wheel 6 to an annular outlet volute passage 91 defined by an annular outlet volute 44.

The axial intake 61 defines an intake passage 77 for gas (such as air). The axial intake 61 has a ‘Map Width Enhancement’ (MWE) inlet structure comprising an outer tubular wall 79 (see FIG. 2) that extends axially inboard (i.e. towards the annular diffuser passage 23) from the intake port 80, which is defined by a radially inner surface of the outer tubular wall 79.

References to ‘axially inboard’ and ‘axially outboard’ are in relation to the diffuser passage 23. In this respect, references to axially inboard and axially outboard refer to axial directions towards and away from the diffuser passage 23 respectively.

The axial intake 61 also comprises an inner tubular wall 54 that extends upstream from the impeller wheel 6, terminating axially inboard of the intake port 80. A radially inner surface of the inner tubular wall 54 defines the compressor inducer 55.

An annular intermediary surface 50 extends from the axially inboard end of the radially inner surface of the inner tubular wall 54 and is an extension of said inner surface. As the intermediary surface 50 extends axially inboard from the axially inboard end of the inner surface, it curves from being substantially parallel to the axial direction 4a, b to being substantially parallel to the radial direction (i.e. substantially perpendicular to the axial direction 4a, b). The intermediary surface 50 defines the chamber 63 in which the impeller wheel 6 is rotatably mounted.

The impeller wheel 6 has a plurality of blades 45 each of which has a front edge 46, a tip 47 and a curved edge 49 extending between the front edge 46 and tip 47. As the impeller wheel 6 rotates, the intermediary surface 50 of the housing 2 is swept by the curved edges 49 of the impeller blades 45.

An annular flow passage 25 surrounds the inducer 55 between the inner and outer tubular walls 54 and 79 respectively. The flow passage 25 is open to the intake port 80 at its upstream end and is closed at its downstream end by an annular wall 39 of the housing 2. The annular passage 25 however communicates with the impeller wheel 6 via apertures 62 formed through the housing (through the tubular inner wall 54 in this instance) and which communicate between a downstream portion of the annular flow passage 25 and the intermediary surface 50.

In between the compressor housing 2 and the bearing housing 3 is a diffuser plate 2a which accommodates an inboard portion of the impeller wheel 6.

The annular diffuser passage 23 extends in the radial direction from a diffuser inlet 48, that is in fluid communication with the impeller wheel 6, to a diffuser outlet 51 that is in fluid communication with the annular outlet volute passage 91. The annular diffuser passage 23 is defined by first and second radially extending surfaces 81, 83. The first and second radially extending surfaces 81, 83 are inboard surfaces of first and second annular diffuser wall members 82, 84 respectively.

In the described embodiment the annular diffuser first wall member 82 is formed by a wall of the bearing housing 3. Accordingly, it will be appreciated that the wall of the bearing housing 3 forms part of the compressor 40. The opposed radially extending surfaces surfaces 81, 83 are substantially parallel to each other and are substantially perpendicular to the shaft axis 4b. The first and second radially extending surfaces 81, 83 each have the general shape of a ring, substantially centred on the shaft axis 4b (and therefore the compressor axis 4a).

The volute passage 91 is defined by an inner surface 90 of the outlet volute 44 and extends, along a circumferentially extending volute passage axis 99, about the shaft axis 4b. The volute 44 has a general scroll shape.

The inner surface 90 of the volute 44 extends, in a circumferential direction about the volute passage axis 99, from a first end provided at the outlet end of the surface 81 of the first diffuser wall member 82 to a second end provided at the outlet end of the surface 83 of the second annular diffuser member 84. The inner surface 90 has a substantially constant radius, relative to the volute passage axis 99, such that the inner surface 90 has a substantially circular cross-sectional shape about the volute passage axis 99. The volute passage 91 fluidly connects the impeller wheel 6 to an outlet (not shown) of the volute 44.

Gas flowing from the turbine inlet volute 7 to the outlet passage 8 passes over the turbine wheel 5 and as a result torque is applied to the shaft 4 to drive the impeller wheel 6. Rotation of the impeller wheel 6 within the compressor housing 2 draws ambient air in through the intake port 80, through the axial intake 61 to the impeller wheel 6, which pressurises the air and delivers the pressurised air through the annular diffuser passage 23 to the outlet volute 44. The air is then delivered from the volute outlet to an internal combustion engine (not shown). The conventional MWE compressor illustrated in FIGS. 1 and 2 operates as described above. In summary, when the flow rate through the compressor 40 is high, air passes axially along the axial intake 61 towards the impeller wheel 6, flowing to the impeller wheel 6 through the inducer 55 and via the annular passage 25, through the apertures 62. When the flow through the compressor 40 is low, the direction of air flow through the annular passage 25 is reversed so that air passes from the impeller wheel 6, through the apertures 62, through the annular flow passage 25 in an upstream direction and is re-introduced into the inducer 55 for re-circulation through the compressor 40. This stabilises the performance of the compressor 40 improving both the surge margin and choke flow.

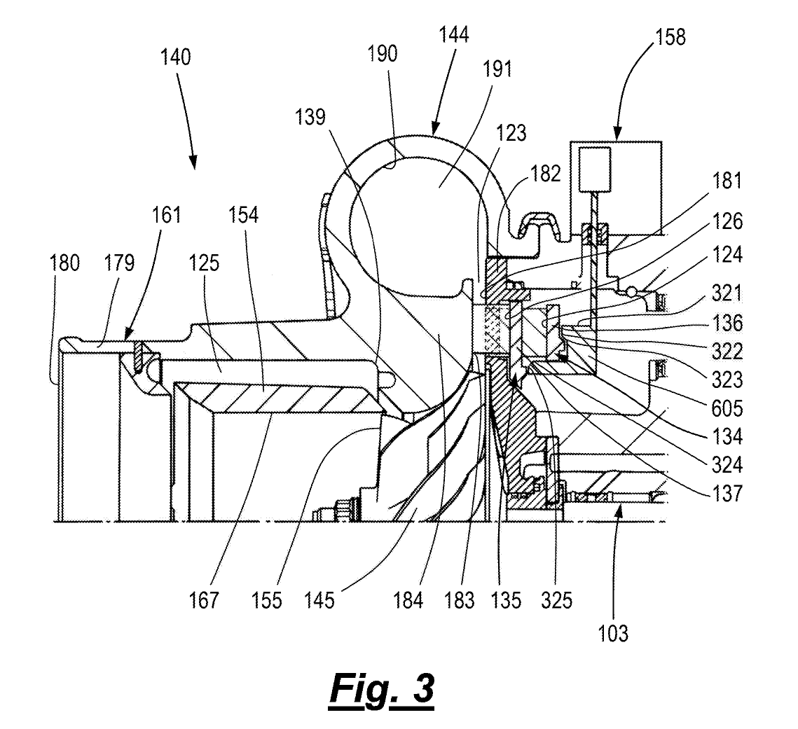

Referring to FIGS. 3 to 7, there is shown a compressor 140 according to a first embodiment of the present disclosure. The compressor 140 is substantially identical to the compressor 40 shown in FIGS. 1 and 2 except for the differences described below. Corresponding features will be labelled with the same reference numerals incremented by 100.

The compressor 140 comprises first and second vane members in the form of first and second vane rings 134, 135. Each vane ring 134, 135 comprises an annular vane ring wall 136, 137 with a plurality of vanes 127, 128 extending axially away from an axially inboard surface 124, 126 of the respective vane ring wall 136, 137.

The vanes 127, 128 of each vane ring 134, 135 are distributed about the vane ring wall 136, 137 in the circumferential direction (relative to the shaft axis 4b). Each vane ring 134, 135 is substantially centred on the shaft axis and extends in a circumferential direction about the shaft axis 4b.

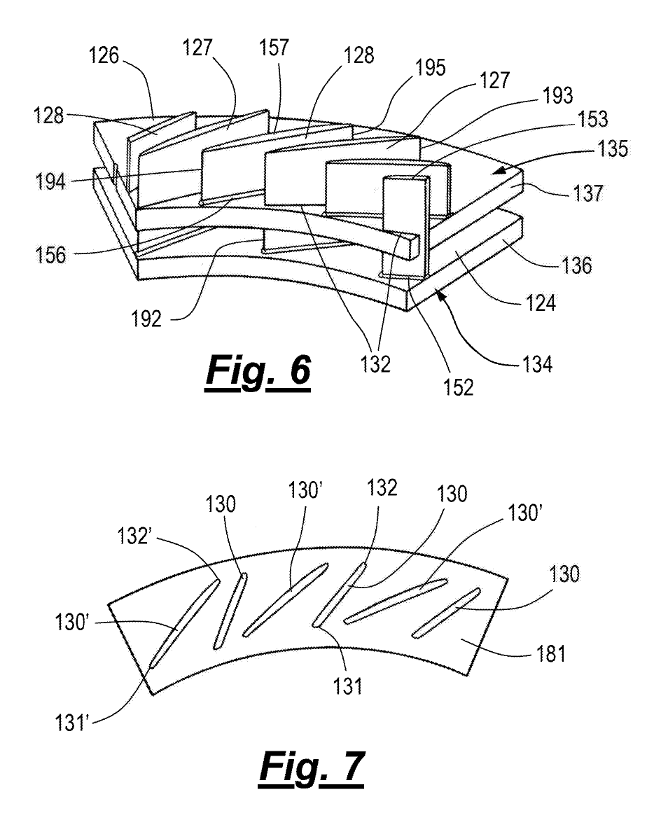

Each of the vanes 127, 128 of the vane rings 134, 135 extends in the axial direction 4b from an axially inner end 152, 156 located at said axially inboard surface 124, 126 of the respective vane ring wall 136, 137 to an axially outer end 153, 157 (see FIG. 6). Each vane has the general cross-sectional shape of an aerofoil and extends from a leading edge 192, 194 to a trailing edge 193, 195.

Referring to FIG. 7, the first wall member 182, that defines the diffuser passage 123, is provided with sets of first and second slots 130, 130′. Each slot 130, 130′ extends in the axial direction 4b from the first surface 181 of the first wall member 182 to an axially outboard surface 197 of the first wall member 182. Each slot 130, 130′ extends from a radially inner end 131, 131′ to a radially outer end 132, 132′. The slots 130, 130′ are distributed in the circumferential direction in an alternating arrangement, i.e. each first slot 130 is circumferentially disposed between a pair of second slots 130′ on either circumferential side of the first slot 130 and each second slot 130′ is circumferentially disposed between a pair of first slots 131 on either circumferential side of the second slot 130′.

The first and second slots 130, 130′ are arranged to receive the vanes 127, 128 of the first and second vane rings 134, 135 respectively. In this respect, each first slot 130 is arranged to receive a respective vane 127 of the first vane ring 134 and each second slot 130′ is arranged to receive a respective vane 128 of the second vane ring 135.

The first and second vane rings 134, 135 are slidably mounted for movement in the axial direction 4b, in a cavity 133 defined between the axially outboard surface 197 of the first wall member 182 and a surrounding inner surface of the bearing housing 103.

Each of the first and second vane rings 134, 135 is slidably mounted within the cavity 133 so as to move in the axial direction 4b between a first position and a second position relative to the diffuser passage 123.

When each vane ring 134, 135 is in its first position, its vanes 127, 128 are located such that they extend axially from the first surface 181 of the first wall member 182, across the axial extent of the diffuser passage 123 to the second surface 183 of the second wall member 184, with the axially outer ends 153, 157 of its vanes 127, 128 abutting the second surface 183 of the second wall member 184. In this regard, each vane 127, 128 extends axially from the respective axially inboard surface 124, 126 of the vane ring 134, 135, through the respective vane slots 130, 130′, across the diffuser passage 123 to the second surface 183 of the second wall member 184.

When each vane ring 134, 135 is in its second position, the vanes 127, 128 of the vane ring 134, 135 are located axially outboard of the diffuser passage 123. In this respect, the axially outer ends 153, 157 of the vanes 127, 128 of the vane ring 134, 135 are located axially outboard of the first surface 181 of the first wall member 182 (on the bearing housing 103 side of the diffuser passage 123).

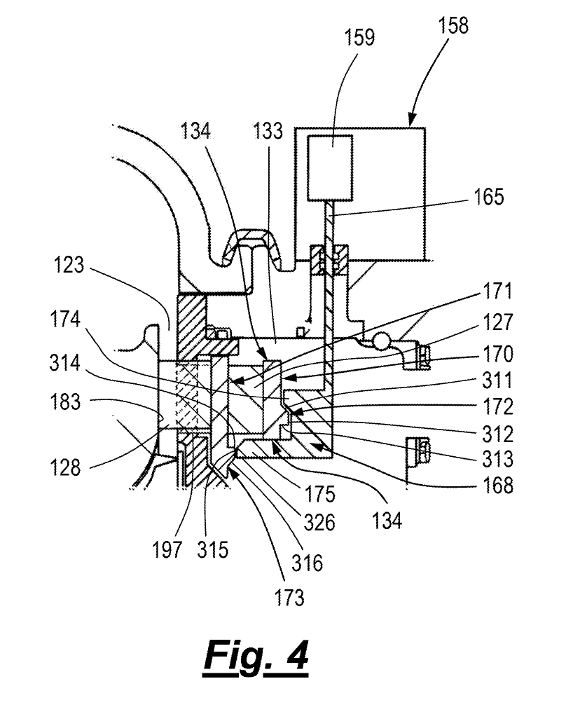

Referring to FIGS. 3 and 4, the vane rings 134, 135 are shown in a first configuration. In this configuration, the first vane ring 134 is in the second position and the second vane ring 135 is in the first position.

In this respect, the vanes 128 of the second vane ring 135 extend substantially across the width of the diffuser passage 123, with the axially outer end 157 of the vanes 128 abutting the second surface 183 of the diffuser passage 123. The vanes 128 of the second vane ring 135 pass from their axially inner end 156, through the slots 130′ in the first wall member 182, across the width of the diffuser passage 123 to the second surface 183 of the diffuser passage 123.

The vanes 127 of the first vane ring 134 are received by the slots 130 in the first wall member 182, with the axially outer end 153 of the vanes 127 disposed axially outboard of the diffuser passage 123, being located within the axial extent of the slots 130.

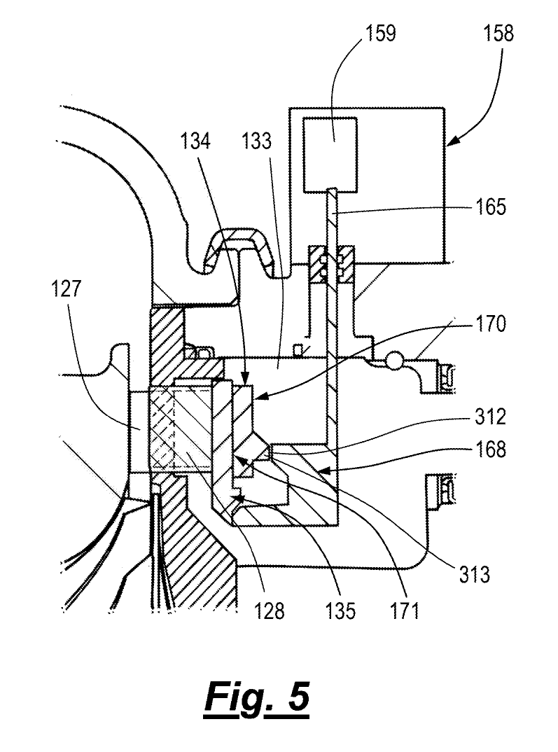

Referring to FIG. 5, the vane rings 134, 135 are shown in a second configuration. In this configuration, the first vane ring 134 is in the first position and the second vane ring 135 is in the second position.

The vane rings 134, 135 are coupled to an actuator assembly 158 that is arranged to move the vane rings 134, 135 between said first and second configurations. Referring to FIG. 4, the actuator assembly 158 comprises an axially reciprocating pneumatic motor 159 connected by an axial drive shaft 165 to a cam member 168.

As described in more detail below, as the cam member 168 is driven in the direction of the longitudinal axis of the drive shaft 165 (which is substantially perpendicular to the turbocharger axis), it engages with the first and second vane rings 134, 135 such that they are moved between said different configurations.

The vane ring wall 136, 137 of each vane ring 134, 135 each has an axially outboard surface 170, 171. Each axially outboard surface 170, 171 is provided with a protrusion 172, 173 that extends in the axially outboard direction from said surface 170, 171. Each protrusion 172, 173 is annular, extending in the circumferential direction relative to the shaft axis 4b.

The protrusion 172 of the first vane ring 134 extends from a radially outer end to a radially inner end along a first surface 311, a second surface 312 and a third surface 313 (see FIG. 4). In this respect, the first surface 311 extends radially inwardly from a radially outer section of the axially outboard surface 170. The first surface 311 is inclined at an oblique angle relative to the radial direction. The second surface 312 extends radially inwardly from a radially inner end of the first surface 311. The second surface 312 is substantially parallel to the radial direction. The third surface 313 extends from a radially inner end of the second surface 312. The third surface 313 is substantially parallel to the axial direction 4b.

The protrusion 173 of the second vane ring 135 extends from a radially outer end to a radially inner end along a first surface 314, a second surface 315 and a third surface 316. In this respect, the first surface 314 extends from a radially outer section of the axially outboard surface 171. The first surface 314 is substantially perpendicular to the radial direction (i.e. substantially parallel to the axial direction 4a, 4b). The second surface 315 extends radially inwardly from an axially outboard end of the first surface 314. The second surface 315 is substantially parallel to the radial direction. The third surface 316 extends radially inwardly, and axially inboard, from a radially inner end of the second surface 315. The third surface 316 is inclined at an oblique angle relative to the radial direction.

The cam member 168 has a generally cylindrical main body 605, extending along a longitudinal axis that is substantially parallel to the radial direction. An axially inboard surface of the main body 605 is substantially parallel to the radial direction. The main body 605 is provided with first and second axially extending protrusions 174, 175 at radially outer and inner ends of the main body 605 respectively. The first and second protrusions 174, 175 extend axially inboard from the main body 605, with the second protrusion 175 extending further axially inboard than the first protrusion 174.

Each protrusion 174, 175 is substantially annular, extending in a circumferential direction about the longitudinal axis of the cam member 168.

The first protrusion 174 extends from a radially outer end to a radially inner end (relative to the turbocharger axis) along a first surface 321, a second surface 322 and a third surface 323. In this respect the first surface 321 extends axially inboard, from the radially outer end of the man body 605, in a direction substantially parallel to the axial direction 4b. The second surface 322 extends radially inwardly from an axially inboard end of the first surface 321. The second surface 322 is substantially parallel to the radial direction. The third surface 323 extends radially inwardly, and axially outboard, from a radially inner end of the second surface 322. The third surface 323 is inclined at an oblique angle to the radial direction. A radially inner end of the third surface 323 joins the axially inboard surface of the main body 605 of the cam member 168.

The second protrusion 175 extends from a radially outer end to a radially inner end along a first surface 324, a second surface 325 and a third surface 326. In this respect the first surface 324 extends radially inwardly, and axially inboard, from a radially outer, axially extending, surface of the second protrusion 175. The first surface 324 is inclined at an oblique angle to the radial direction. The second surface 325 extends radially inwardly from a radially inner end of the second surface 325. The second surface 325 is substantially parallel to the radial direction. The third surface 326 extends from a radially inner end of the second surface 322. The third surface 323 is substantially perpendicular to the radial direction and is provided at a radially inner end of the main body 605 of the cam member 168.

The protrusions 172, 173 of the vane rings 134, 135 and the protrusions 174, 175 of the cam member 168 are arranged such that as the cam member 168 moves in the axial direction, between first and second positions, the protrusions 174, 175 of the cam member 168 engage with the protrusions 172, 173 of the vane rings 134, 135 so as to move the vane rings 134, 135 relative to the diffuser passage 123, between the first and second configurations respectively.

Referring to FIGS. 3 and 4, the vane rings 134, 135 are shown in said first configuration, in which the first vane ring 134 is in the second position and the second vane ring 135 is in the first position. In this configuration, the cam member 168 is in a first position.

The vane rings 134, 135 are biased in the axially outboard direction, to their second positions, by a biasing member (not shown). The biasing member is a resiliently deformable member, for example a spring. Any suitable biasing member may be used.

When the cam member 168 is in its first position, its first protrusion 174 is disposed radially outwardly of the protrusion 172 of the first vane ring 134. In this respect, the second surface 322 of the first protrusion of the 174 of the cam member 168 is disposed axially adjacent to a section of the outboard surface 170 of the vane ring wall 136 that is disposed radially outwardly of, and adjacent to, the protrusion 172 of the first vane ring 134. In this position, the third surface 323 of the first protrusion 174 of the cam member is axially adjacent to the first surface 311 of the protrusion 172 of the first vane ring 134. Said surfaces 323, 311 are substantially parallel to each other. The second surface 312 of the protrusion 172 of the first vane ring 134 is disposed axially adjacent to the axially inboard surface of the main body 605 of the cam member 168. Said surfaces are substantially parallel to each other.

Due to the biasing of the first and second vane rings in the axially outboard direction, the first vane ring 135 is moved by the biasing member to the second position, in which the vanes 127 are disposed axially outboard of the diffuser passage 123. In this respect, the axially outboard end of the vanes 127 is disposed axially outboard of the diffuser passage 123, in the recesses 130 in the first wall member.

When the cam member 168 is in said first position, the second surface 325 of the second protrusion 175 of the cam member 605 engages the second surface 315 of the protrusion 173 of the second vane ring 135.

The engagement of the second surface 325 of the second protrusion 175 of the cam member 168 with the second surface 315 of the protrusion 173 of the second vane ring 135 moves the second vane ring 135 axially inboard against the biasing of the biasing member to the first position, in which its vanes 128 extend substantially across the diffuser passage 123. In this respect, axially outboard ends of the vanes 128 abut the second surface 183 of the diffuser passage 123.

The cam member 168 is movable from the first position, shown in FIGS. 3 and 4, to the second position, shown in FIG. 5. When the cam member 168 is in the second position it is disposed radially inwardly of the first position. The cam member 168 is moved from its first position to its second position (and vice versa) by the motor 159, which moves the drive shaft 165 in the direction of the longitudinal axis of the drive shaft (which is substantially parallel to the radial direction), and which therefore moves the cam member 168 in the radial direction.

As the cam member 168 is moved from its first position to its second position, the third surface 323 of the first protrusion 174 of the cam member 168 slides in the radially inward direction across the first surface 311 of the protrusion 172 of the first vane ring 134. As it does so, the first vane ring 134 is moved axially inboard, against the force of the biasing member, until the second surface 322 of the first protrusion 174 of the cam member 168 is brought into engaging abutment with the second surface 312 of the protrusion 172 of the first vane ring 134. The engagement of these surfaces holds the first vane ring 134 in said first position, against the biasing of the biasing member. In this position, the vanes 127 of the first vane ring 134 extend substantially across the diffuser passageway 123.

As the cam member 168 moves to its second position, the second surface 325 of the second protrusion 175 of the cam member 168 slides radially inwardly off the second surface 315 of the protrusion 173 of the second vane ring 135. The third surface 326 of the second protrusion 175 slides across the first surface 324 of the second protrusion 175 of the cam member 168. When the cam member 168 is in its second position, its second protrusion 175 is disposed radially inwardly of the protrusion 173 of the second vane ring 135. In this position, the first surface 324 of the second protrusion 175 is disposed axially adjacent to the third surface 316 of the protrusion of the second vane ring 135. Said surfaces are substantially parallel to each other.

As the cam member 168 moves to its second position, the biasing of the second vane ring 135 forces the second vane ring 135 in the axially outboard direction, to its second position. In this position, its vanes are disposed axially outboard of the diffuser passage 123.

It will be appreciated that, similarly, movement of the cam member 168 from its second position back to its first position results in movement of the first and second vane rings 134, 135 back from the first and second positions to the second and first positions respectively.

Referring now to FIGS. 6 and 7, in order to allow for the relative axial movement of the first and second vane rings 134, 135, as they move between their first and second positions, the vane ring wall 137 of the second vane ring 135 is provided with a plurality of circumferentially distributed slots 132 arranged to receive the vanes 127 of the first vane ring 134. In this regard, each slot 132 is arranged to receive a respective vane 127 of the first vane ring 134. Each slot 132 has a corresponding shape to the vane 127 that it is arranged to receive. Each slot 132 extends from an axially outboard surface of the vane ring wall 137 to said axially inboard surface 126 of the vane ring wall 137. Each slot 132 also extends from a radially inner end to a radially outer end, whose positions correspond to the leading edge and trailing edge of the respective vane 127 that it is arranged to receive.

Accordingly, as the first and second vane rings 134, 135 move relative to each other between their first and second positions, the vanes 127 of the first vane ring 134 are received within the slots 132 in the second vane ring 135. Accordingly the slots 132 allow the relative movement of the first and second vane rings 134, 135. Each slot 132 is disposed in between an adjacent pair of the vanes 128 of the second vane ring 135. Accordingly, as the vanes 127 of the first vane ring 134 are received within the slots 132, each vane 127 of the first vane ring 134 passes between a pair of circumferentially adjacent vanes 128 of the second vane ring 135.

The above arrangement of the axially movable first and second vane rings 134, 135 is advantageous in that in the first configuration (when the first vane ring 134 is in its second position and the second vane ring 135 is in its first position), the vanes 127 of the first vane ring 134 are not located within the diffuser passage 123 and the vanes 128 of the second vane ring 135 are located within the diffuser passage 123. In the second configuration, the vanes 127 of the first vane ring 134 are located in the diffuser passage 123 and the vanes 128 of the second vane ring 135 are not located within the diffuser passage 123.

The vanes 127 of the first vane ring 134 are shaped and oriented so as to provide an efficiency gain at a first operating point of the impeller wheel 6 (e.g. speed of the impeller wheel 6) and the vanes 128 of the second vane ring 135 are shaped and oriented so as to provide an efficiency gain at a second operating point of the impeller wheel 6.

Accordingly, moving the vane rings 134, 135 between the first and second configurations allows the operating point at which the efficiency gain is achieved to be varied. This therefore allows an efficiency gain to be provided at different operating points of the impeller wheel 6.

In this respect, the actuator assembly 158 is controlled by an engine control unit (not shown). The engine control unit is arranged to move the first and second vane rings 134, 135 in dependence on a certain operating condition of the compressor (e.g. speed of the impeller wheel 6) so as to provide an efficiency gain at that operating condition.

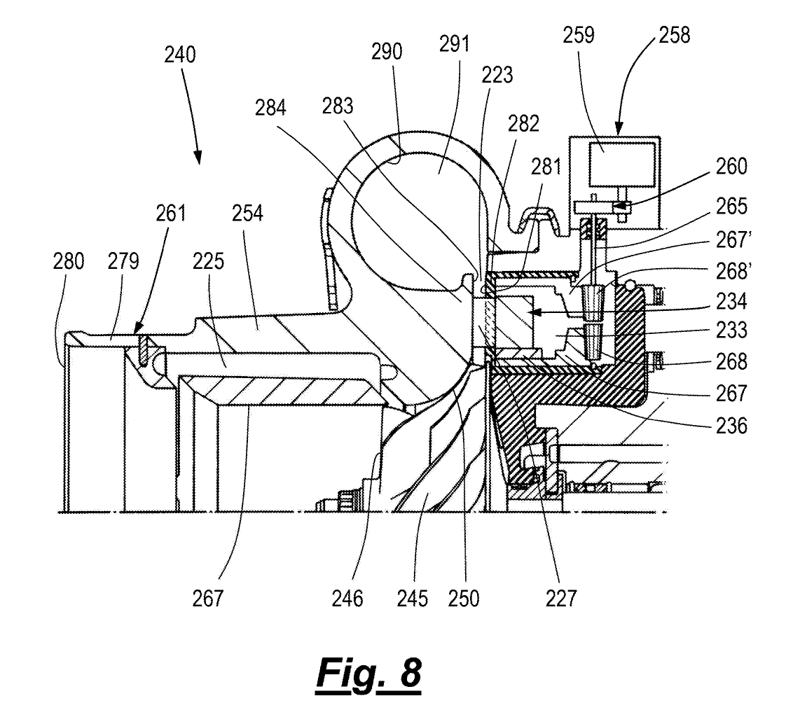

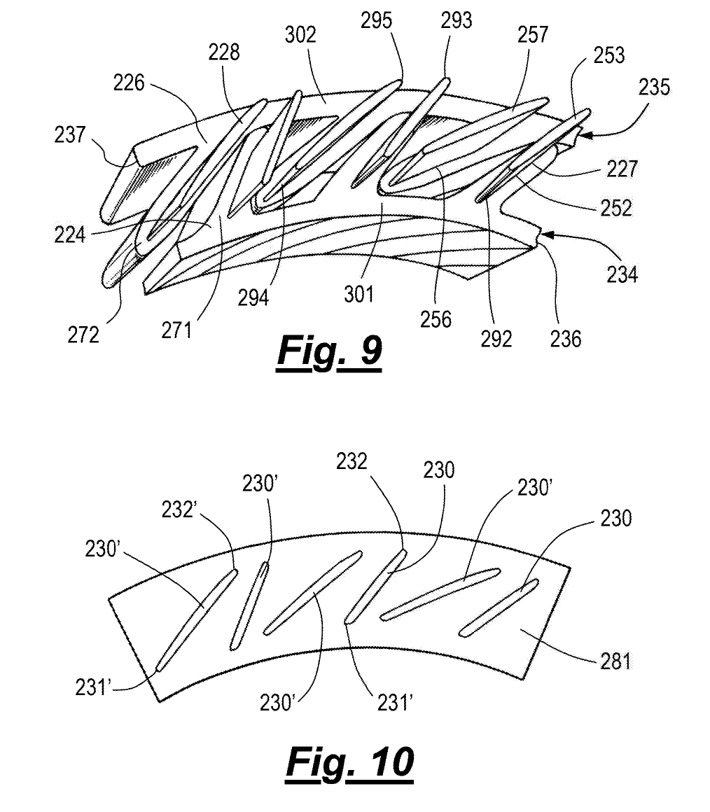

Referring to FIGS. 8 to 10, there is shown a compressor 240 according to a second embodiment of the disclosure. The compressor 240 is substantially identical with the compressor 140 of the first embodiment except for the differences described below. Corresponding features will be labelled with the same reference numerals incremented by 100.

In the second embodiment the first and second vane rings 234, 235 differ from the first and second vane rings 134, 135 of the first embodiment in that the vanes 227, 228 of the respective vane rings 234, 235 are each mounted on respective radially extending webs 271, 272. The radially extending webs 271 of the first vane ring 234 extend radially outwardly from an annular wall member 301. The radially extending webs 272 of the second vane ring 235 extend radially inwardly from an annular wall member 302.

The radially extending webs 271, 272 are spaced, in a circumferential direction, such that when the first vane ring 234 moves axially relative to the second vane ring 235, each web 271, and the respective vane 127 mounted thereon, of the first vane ring 234 is received in between a pair of circumferentially adjacent webs 272, and their respective vanes 228, of the second vane ring 235 (and vice versa). This allows the first and second vane rings 234, 235 to move axially relative to each other between their respective first and second positions.

Furthermore, in the second embodiment the vane rings 234, 235 are coupled to a different actuator assembly 258 arranged to move the vane rings 234, 235 between said different configurations. The actuator assembly 258 comprises first and second rotational electric motors (in the Figures only the first motor 259 is shown) coupled by a transmission, in the form of engaged gear wheels (in the Figures only the first set of engaged gear wheels 260 is shown), to first and second drive shafts (in the Figures only the first drive shaft 265 is shown).

First and second pinion wheels 268, 268′ are mounted on first and second drive shafts respectively, so as to rotate with the drive shaft.

In the second embodiment, the vanes 227, 228 extend axially inboard from a vane ring wall 236, (not shown) that is disposed along a radially inner edge of the vanes 227, 228 (as opposed to being provided at the axially inboard end of the vanes as in the first embodiment).

Each vane ring wall 236, (not shown) is attached along a radially inner surface to a rack member 267, 267′. Each rack member 267, 267′ is provided with a plurality of teeth (not shown) arranged to form a rack. The teeth of the rack members 267, 267′ of the first and second vane rings are engaged with the teeth of the first and second pinion wheels 268, 268′ respectively, such that rotation of the first and second pinion wheels moves the respective rack member, and therefore the respective vane ring, in the axial direction.

As with the first embodiment, moving the vane rings 234, 235 between said different configurations allows the operating point at which the efficiency gain is achieved to be varied. This therefore allows an efficiency gain to be provided at different operating points of the impeller wheel 6.

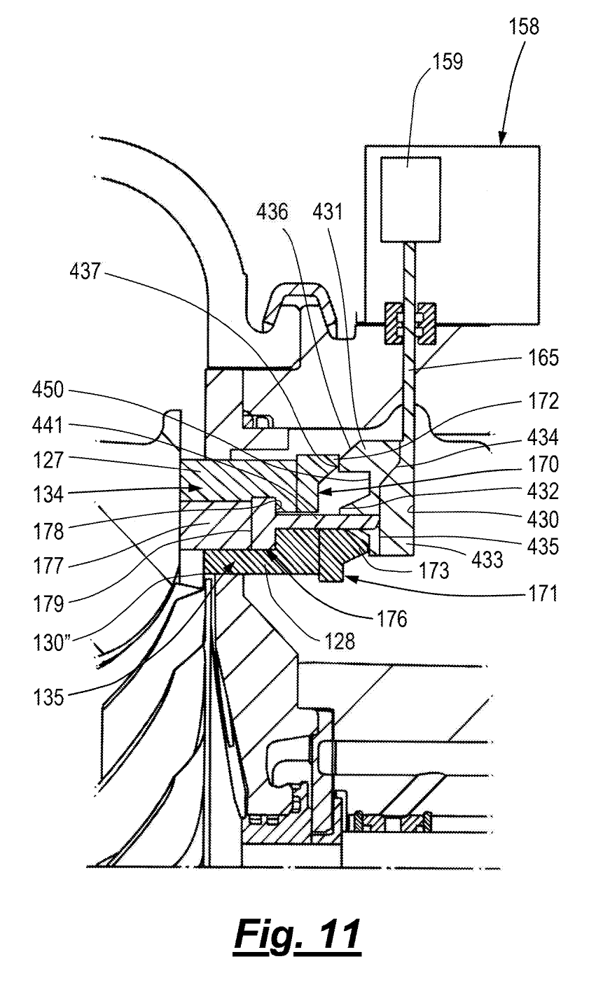

Referring to FIGS. 11-13, there is shown a modified version of the first embodiment shown in FIGS. 3-7. The modified embodiment is identical to that shown in FIGS. 3-7, except for the differences described below. Corresponding features are given corresponding reference numerals.

The modified embodiment differs from that shown in FIGS. 3-7 in that it comprises a third vane ring 176. In addition, the arrangement of the protrusions 172, 173 of the first and second vane rings 134, 135 and of the protrusions on the cam member 430 is different to that of the second embodiment shown in FIGS. 3-7, as will be described in more detail below.

The third vane ring 176 is generally similar to the first and second vane rings 134, 135 and comprises a plurality of circumferentially distributed vanes 177 that extend from an axially inner end, attached to a vane ring wall 180, to an axially outer end.

The cam member 430 is a generally elongate body extending in a longitudinal direction from the second end of the drive shaft 165. The cam member 430 comprises a first protrusion 431, a second protrusion 432 and a third protrusion 433 that extend in the axially inboard direction away from the longitudinal axis of the cam member 430. The first and second protrusions 431, 432 extend axially inboard to substantially the same axial position. The first and second protrusions 431, 432 extend further axially inboard than the third protrusion 433.

The first and second protrusions 431, 432 are provided on a first circumferential section of the cam member 430. The third protrusion 433 is provided on a second circumferential section of the cam member 430 that is disposed circumferentially adjacent to the first circumferential section in the circumferential direction relative to the longitudinal axis of the cam member 430. Each of the protrusions 431, 432, 433 is substantially annular, extending in a circumferential direction about the longitudinal axis of the cam member 430.

The first protrusion 431 extends from a radially outer end (relative to the turbocharger axis) to a radially inner end along a first surface 436 and a second surface 437. In this respect, the first surface 436 extends radially inwardly, and axially inboard, from the radially outer end of the cam member 430, in a direction inclined at an oblique angle to the radial direction (relative to the turbocharger axis). The second surface 437 extends from a radially inner end of the first surface 436 in a direction substantially parallel to the radial direction. The first protrusion 431 is joined to the second protrusion 432 by an intermediary surface 450. The intermediary surface 450 is located axially outboard of the second surface 437 of the first protrusion 431 and extends substantially parallel to the radial direction (relative to the turbocharger axis).

The second protrusion 432 extends from a radially outer end to a radially inner end along a first surface 438, a second surface 439 and a third surface 440. In this respect, the first surface 438 extends axially outboard, and radially inwardly, from a radially inner end of the intermediary surface 450, at an oblique angle relative to the radial direction. The second surface 439 extends radially inwardly from a radially inner end of the first surface 438 and extends substantially parallel to the radial direction. The third surface 440 extends from a radially inner end of the second surface 439 and extends radially inwardly, and axially outboard, at an oblique angle relative to the radial direction. An end surface 451 extends radially inwardly from a radially inner end of the third surface 440 and is substantially parallel to the radial direction.

The third protrusion 433 extends from a radially outer end to a radially inner end along a first surface 434 and a second surface 435. In this respect, the first surface 434 extends radially inwardly and axially outboard, from a radially outer end of the third protrusion 433, at an oblique angle to the radial direction. The second surface 435 extends radially inwardly from a radially inner end of the first surface 434. The second surface 435 is substantially parallel to the radial direction.

As with the embodiments shown in FIGS. 3 to 7 (but with the addition of the third vane ring in this embodiment), each vane ring wall 136, 137, 180 of each vane ring 134, 135, 176 is provided with a protrusion 172, 173, 441 that extends in the axially outboard direction from the axially outboard surface 170, 171, 178 of the vane ring wall 136, 137, 180. Each protrusion 172, 173, 441 is annular, extending in a circumferential direction relative to the shaft axis 4b.

The protrusion 172 of the first vane ring 134 extends from a radially outer end to a radially inner end (relative to the shaft axis 4b) along a first surface 442 and a second surface 443. In this respect, the first surface 442 extends radially inwardly from the radially outer end of the protrusion 172 in a direction that is substantially parallel to the radial direction. The second surface 443 extends in the axially inboard direction from the radially inner end of the first surface 442 at an oblique angle to the radial direction. A section of the axially outboard surface 170 of the vane ring wall extends from the radially inner end of the second surface 443 to a radially inner end of the vane ring wall in a direction that is substantially parallel to the radial direction.

The protrusion 173 of the second vane ring 135 extends from a radially outer end to a radially inner end along a first surface 444, a second surface 445 and a third surface 446. In this respect, the first surface 444 extends from the radially outer end of the protrusion 173, in the axially outboard direction at an oblique angle to the radial direction. The second surface 445 extends from a radially inner end of the first surface 444, in a direction substantially parallel to the radial direction. The third surface 446 extends from a radially inner end of the second surface 445, in the axially inboard direction at an oblique angle to the radial direction. The axially outboard surface of the vane ring wall extends from the radially inner end of the third surface 446 to a radially inner end of the protrusion 473 in a direction that is substantially parallel to the radial direction.

The protrusion 441 of the third vane ring 176 extends from a radially outer end to a radially inner end along a first surface 447 and a second surface 448. In this respect, the first surface 447 extends from a radially outer end of the protrusion 441 in a direction that is substantially parallel to the radial direction. The second surface 448 extends axially inboard from a radially inner end of the first surface 447 at an oblique angle to the radial direction, terminating at a radially inner end.

As with the embodiments shown in FIGS. 3 to 7, each vane ring 134, 135, 176 is movable from a first position in which the vanes of the vane ring extend substantially across the diffuser passage 123 to a second position in which the vanes are disposed axially outboard of the diffuser passage 123. When the vane rings are in the first position, the axially outer ends of the vanes abut the second surface of the diffuser passage 123. When the vane rings are in the second position, the axially outer ends of the respective vanes are disposed axially outboard of the diffuser passage 123 in respective slots 130, 130′, 130″ in the first wall member 182 of the diffuser 164.

The vane rings 134, 135, 176 are biased into their second positions by a biasing member (not shown). The biasing member is a resliently deformable member, such as a spring. The biasing member may be of any suitable type.

Referring to FIG. 11, the vane rings 134, 135, 176 are shown in a first configuration. In the first configuration, the first and third vane rings 134, 176 are in the first position and the second vane ring 135 is in the second position. In this configuration, the cam member 430 is in a first position.

When the cam member 430 is in its first position, its first protrusion 431 is in contact with the protrusion 172 of the first vane ring 134. In this respect, the second surface 437 of the first protrusion 431 is in abutment with the first surface 442 of the protrusion 172 of the first vane ring 134. The engagement of the first protrusion 431 of the cam member 430 and the protrusion 172 of the first vane ring, forces the first vane ring 134 axially inboard against the biasing of the biasing member to the first position (i.e. in which the vanes 127 extend substantially across the diffuser passage 123).

When the cam member 430 is in the first position, the second surface 435 of the third protrusion 433 of the cam member 430 is in abutment with the first surface 447 of the protrusion 441 of the third vane ring 176. Said second surface 435 of the third protrusion 433 is disposed axially inboard of the second surface 437 of the first protrusion 431 and of the second surface 439 of the second protrusion 432. However, the protrusion 441 of the third vane ring 176 is longer in the axial direction than the protrusions 172, 173 of the first and second vane rings 134, 135. Accordingly, in this position, the third vane ring 176 is axially located in the first position, i.e. in which its vanes 177 extend substantially across the diffuser passage 123. The engagement of the second surface 447 of the third protrusion 433 and the second surface 448 of the protrusion 441 of the third vane ring moves the third vane ring 176 axially inboard against the biasing of the biasing member to the first position.

When the cam member 430 is in its first position, the second protrusion 432 of the cam member 430 is disposed radially outwardly of the protrusion 173 of the second vane ring 135. In this respect, the second surface 445 of the protrusion 173 of the second vane ring 135 is in abutment with the end surface 451 of the second protrusion 432 of the cam member 430. Accordingly, the biasing of the biasing member forces the second vane ring 135 axially outboard to its second position.

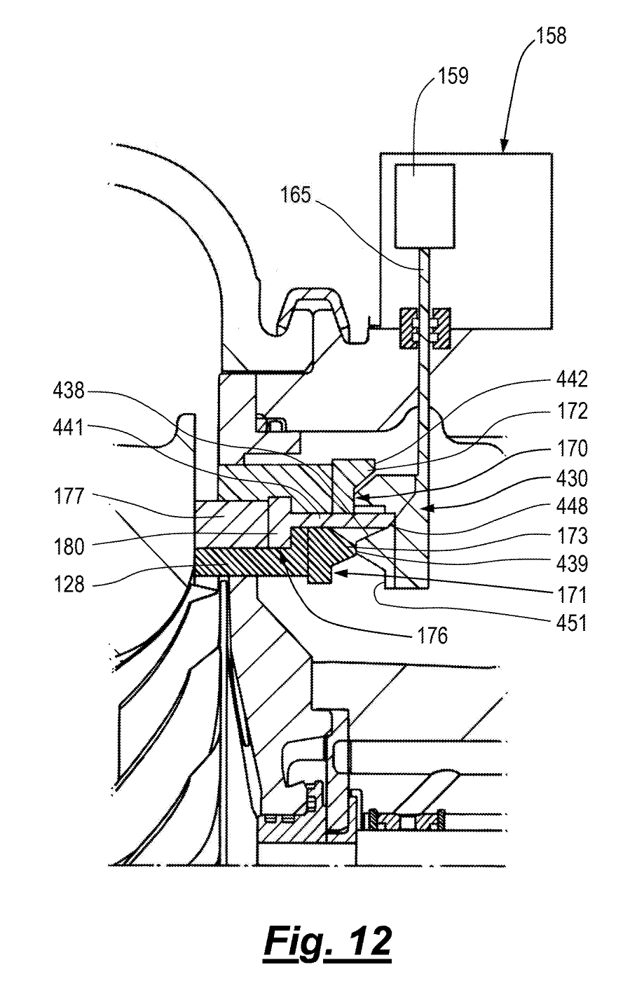

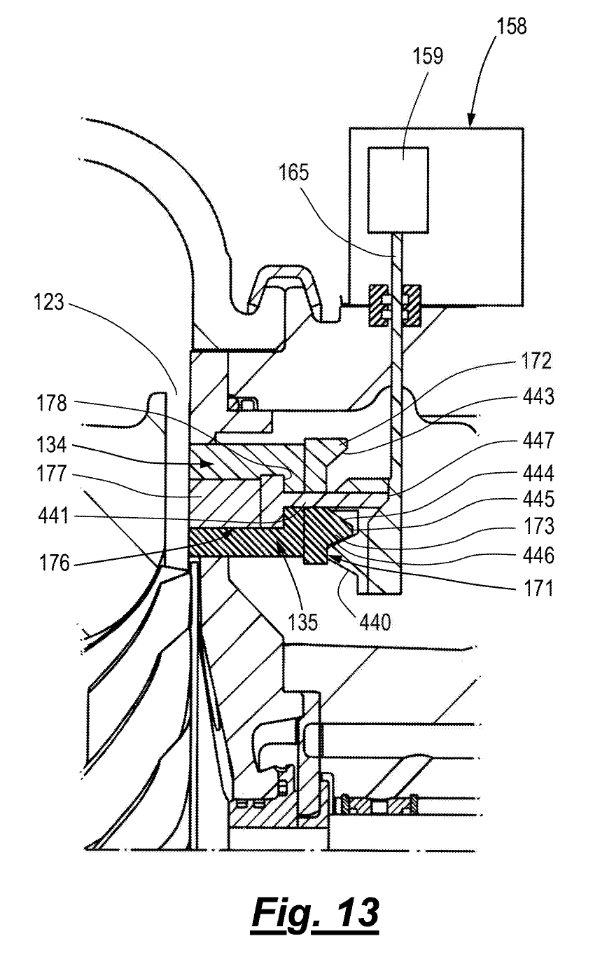

The cam member 430 is movable from its first position shown in FIG. 11 to a second position shown in FIG. 12. When the cam member 430 is in its second position, it is disposed radially inwardly of the first position (relative to the shaft axis 4b). The cam member 430 is moved from its first position to its second position (and vice versa) by a pneumatic actuator 159, which moves the drive shaft 165 in direction of the longitudinal axis of the drive shaft (which is in the radial direction), and which therefore moves the cam member 430 in the radial direction.

The pneumatic actuator 159 may be arranged to bias the vane rings 134, 135, 176 into their second positions

As the cam member 430 is moved from its first position to its second position, the second surface 437 of the first protrusion 431 of the cam member 430 slides radially inwardly across the first surface 442 of the protrusion 172 of the first vane ring 134, across the second surface 443 of said protrusion 172 to the axially outboard surface of the vane ring wall, which it remains in abutment with. Since the axially outboard surface is disposed axially inboard of the first surface 442 of the protrusion 172, as the cam member 430 moves from its first position to its second position, the biasing force of the biasing member moves the first vane ring 134 axially inboard to its second position.

When the cam member 430 is in its second position, the first surface 447 of the protrusion of the third vane ring 176 remains in contact with the second surface 435 of the third protrusion 433 of the cam member 430. Accordingly, the third vane ring 176 remains in its first position.

As the cam member 430 moves from its first position to its second position, the second protrusion 432 of the cam member 430 engages the protrusion 173 of the second vane ring 135, which moves the second vane ring axially inboard against the biasing of the biasing member until the vane ring 135 is in its first position. In this regard, as the cam member 430 moves from its first position to its second position, the second surface 445 of the protrusion 173 of the second vane ring 135 slides along the third surface 440 and then the second surface 439 of the second protrusion 432 of the cam member 430 until the second surface 445 of the protrusion 173 is in abutment with the second surface 439 of the second protrusion 432 of the cam member 430. The engagement of these surfaces forces the second vane ring 135 axially inboard against the biasing of the biasing member to its first position.

When the cam member 430 is in its second position, the vane rings are in a second configuration. In the second configuration the first vane ring 135 is in its second position and the second and third vane rings 135, 176 are in their first position.

The cam member 430 is movable to a third position, as shown in FIG. 13. In its third position, the cam member 430 is disposed radially inwardly of the second position.

As the cam member 430 moves from its second position (shown in FIG. 12) to its third position, the second surface 437 of the first protrusion 431 of the cam member 430 remains in contact with the second surface 443 of the protrusion 172 of the first vane ring 134. Accordingly, the first vane ring 134 remains in its second position as when the cam member 430 is in its second position.

As the cam member 430 moves from its second position to its third position, the second surface 448 of the protrusion 441 of the third vane ring 176 moves along the first surface 434 of the third protrusion 433 of the cam member 430. As it does so, the biasing force of the biasing member moves the third vane ring 176 in the axially outboard direction to its second position.

As the cam member 430 moves from its second position to its third position, its second protrusion 432 moves radially inwardly of the protrusion 173 of the second vane ring 135. In this regard, the second surface 439 of the second protrusion 432 slides across the second and third surfaces 445, 446 of the protrusion 173 of the second vane ring 135 until it reaches the radially outer section of the axially outboard wall of the second vane ring. As it does so, the biasing force of the biasing member moves the second vane ring 135 in the axially outboard direction to its second position.

When the cam member 430 is in its third position, the vane rings are in a third configuration. In the third configuration the first, second and third vane rings 135, 136, 176 are each in the second position.

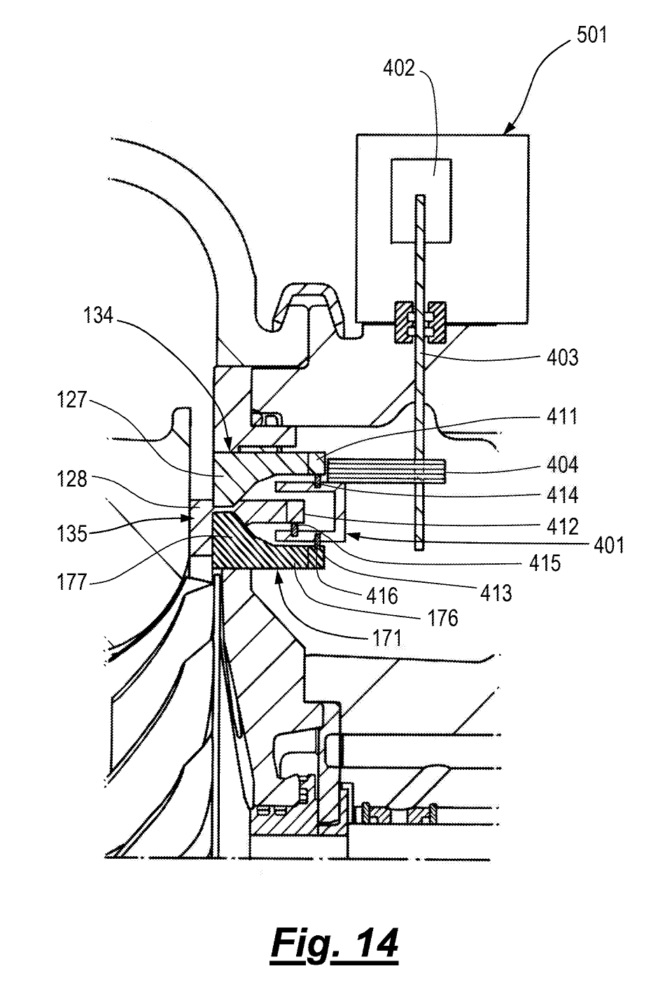

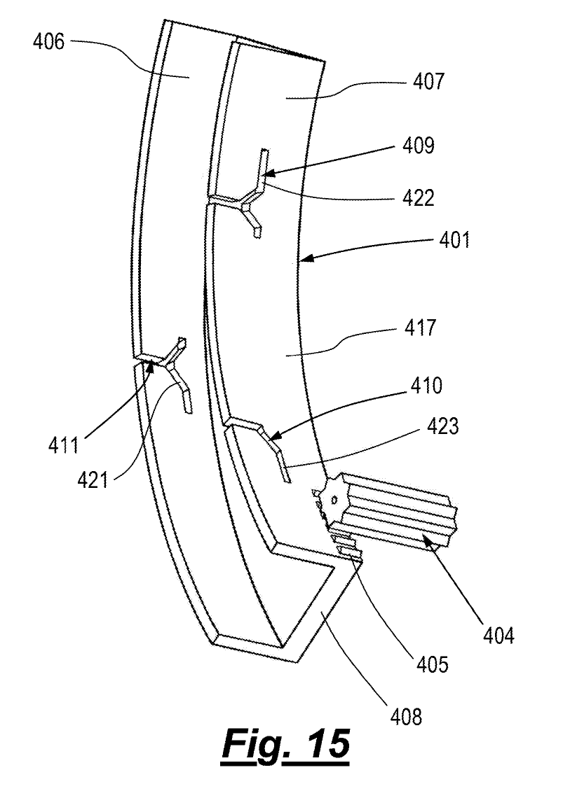

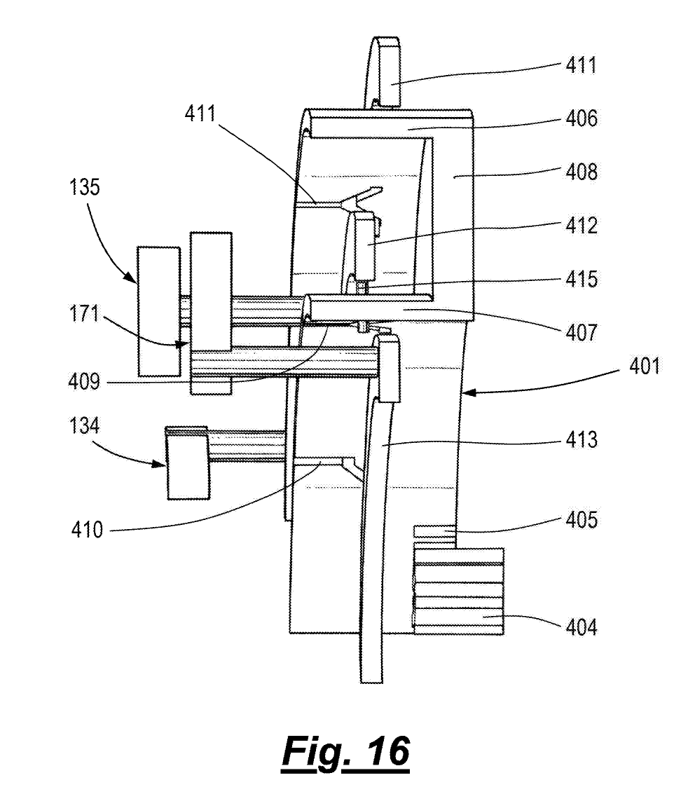

Referring to FIGS. 14-20 there is shown a compressor according to a third embodiment of the disclosure. The compressor of the third embodiment is identical to that of the second embodiment, except for the differences described below. Corresponding features are given like reference numerals. FIG. 16 shows an axial perspective view of a portion of an actuator assembly of a slightly different version to that shown in FIG. 14, but corresponding features are given corresponding reference numerals.

The compressor of the third embodiment differs from that of the modified first embodiment in how the first, second and third vane rings 134, 135, 176 are actuated between said different configurations.

In this regard, the actuator assembly 501 comprises an actuator in the form of an electrical rotational motor 402 that is arranged to rotatably drive a rotary drive shaft 403 about its longitudinal axis. The rotational motor 402 is drivably connected to the drive shaft 403 at a first end of the drive shaft 403. A toothed pinion wheel 404 is mounted to the drive shaft 403, towards a second end of the drive shaft 403, for rotation with the drive shaft 403.

The actuator assembly 501 further comprises a cam ring 401. The cam ring 401 is substantially annular and is substantially centred on the shaft axis 4b. The cam ring 401 comprises a radially outer flange 406 and a radially inner flange 407. Each of the radially outer and inner flanges 406, 407 are substantially annular, extending circumferentially about shaft axis 4b and each extending substantially parallel to the axial direction 4b. Opposed outboard ends of the radially outer and inner flanges 406, 407 are connected to each other by a radially extending web 408. The web 408 extends substantially parallel to the radial direction and is substantially annular. Accordingly, the cam ring 401 has a substantially U-shaped cross sectional shape (with a flat base) that extends along a curved longitudinal axis that is substantially centred on the shaft axis 4b.

A radially inner surface 417 of the radially inner flange 407 is provided with a series of teeth, distributed in the circumferential direction, to form a rack 405. The teeth of the rack 405 are engaged with the teeth of the pinion wheel 404 such that the pinion wheel 404 (driven by the rotation of the motor 402) rotates the cam ring 401 in the circumferential direction, about the shaft axis 4b (as described in more detail below).

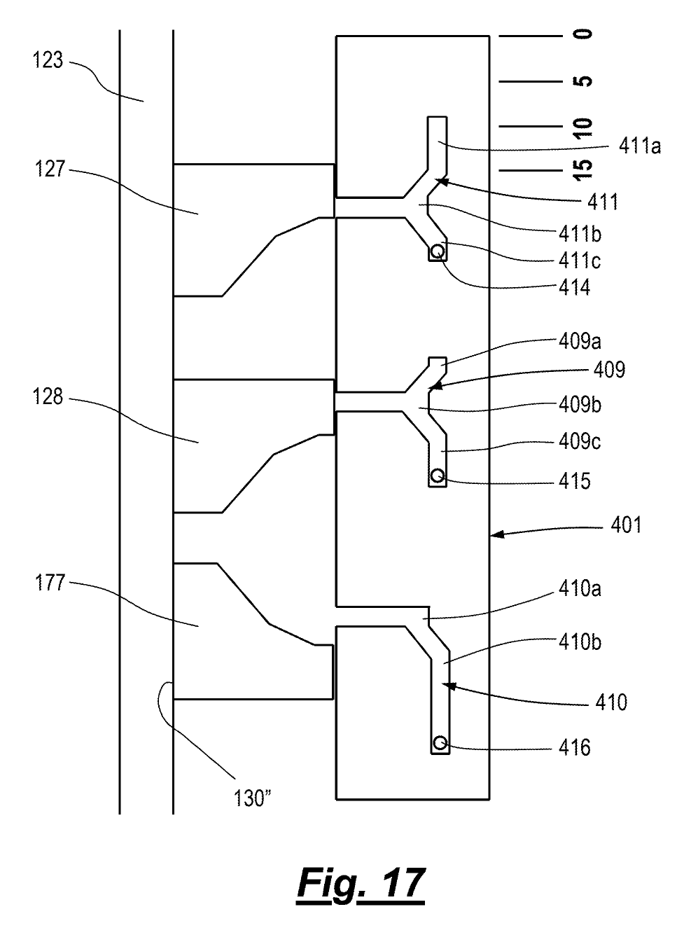

The radially outer flange 406 is provided with a first slot 411 defined by an inner surface 421 of the radially outer flange 406. The slot 411 extends generally in the circumferential direction and comprises first, second and third sections 411a, 411b, 411c (see FIG. 17). The first and second sections 411a, 411b, are provided on circumferentially adjacent sides of the second section 411b. The second section 411b is located axially inboard of the first and third sections 411a, 411c. Each of the first, second and third sections 411a, 411b, 411c are sections of the slot that extends substantially parallel to the circumferential direction. The second section 411b is joined to the first and third sections 411a, 411c by intermediary sections of the slot 411 that are inclined relative to the circumferential direction. The first and third sections 411a, 411c are substantially aligned with each other in the axial direction.

The radially inner flange 407 is provided with a second slot 409 defined by an inner surface 422 of the radially inner flange 407. The slot 409 extends generally in the circumferential direction and comprises first, second and third sections 409a, 409b, 409c. The first and third sections 409a, 409c, are provided on circumferentially adjacent sides of the second section 409b. The second section 409b is located axially inboard of the first and third sections 409a, 409c. Each of the first, second and third sections 409a, 409b, 409c are sections of the slot that extends substantially parallel to the circumferential direction. The second section 409b is joined to the first and third sections 409a, 409c by intermediary sections of the slot 409 that are inclined relative to the circumferential direction. The first and third sections 409a, 409c are substantially aligned with each other in the axial direction.

The radially inner flange 407 is also provided with a third slot 410 circumferentially spaced from the second slot 409. The third slot 410 comprises first and second circumferentially adjacent sections 410a, 410b. The first and second sections 410a, 410b are substantially parallel to the circumferential direction. The second section 410b is disposed axially outboard of the first section 410a. The first and second sections 410a, 410b are connected by an intermediary section of the slot that is inclined relative to the circumferential direction.

The first, second and third vane rings 134, 135, 176, are each provided with a respective protrusion 414, 415, 416 that extends radially inwardly from a radially inner surface of the respective vane ring wall 136, 137, 176. The first, second and third protrusions 414, 415, 416 are slidably mounted within the first, second and third slots 411, 409, 410 respectively so as to slide relative to the slot, along the length of the slot.

As described in more detail below, as the cam ring 401 is rotated by the rotary motor 402, the first, second and third slots 411, 409, 410 travel in the circumferential direction relative to the first, second and third protrusions 414, 415, 416 respectively. Due to the different axial positions of the first, second and third sections of the slots 411, 409, 410, respective inner surfaces that define the slots act on the protrusions 414, 415, 416 so as to move them, and therefore the vane rings are 134, 135, 171 in the axial direction relative to the diffuser passage 123.

It will be appreciated that FIGS. 17 to 20 are schematic views showing the cam ring 401 adjacent to the vanes 127, 128, 177 for illustrative purposes only. Furthermore, the first, second and third slots 411, 409, 410 are shown circumferentially adjacent to each other for illustrative purposes. However it will be appreciated that the first slot 411 is provided in the radially outer flange 406 of the cam ring 401 and the second and third slots 409, 410 are provided in the radially inner flange 407 of the cam ring 401.

Referring to FIG. 17, the cam ring 401 is shown in a first rotational position. In this rotational position, the vanes 127, 128, 177 of the vane rings 134, 135, 171 are disposed in a first configuration. In the first configuration, the vanes 127, 128, 177 of the first, second and third vane rings 134, 135, 171 are located axially outboard of the diffuser passage 123. In this respect, axially outboard ends of the vanes 127, 128, 177 are disposed axially outboard of the diffuser passage 123, in respective recesses 130, 130′, 130″ in the first wall member 82.

In more detail, when the cam ring 401 is in its first rotational position, the protrusions 414, 415 of the first and second vane rings 134, 135 are located at a first end of the respective third sections 411c, 409c of the first and second slots 411, 409 respectively. Furthermore, the protrusion 416 of the third vane ring 171 is located at a first end of the second section 410b of the third slot 410. When the protrusions 414, 415, 416 are located in these positions relative to the respective slots 411, 409, 410 the vane rings 134, 135, 171 are located in said first configuration, i.e. they are located such that the vanes 127, 128, 177 are disposed axially outboard of the diffuser passage 123 (as shown in FIG. 17).

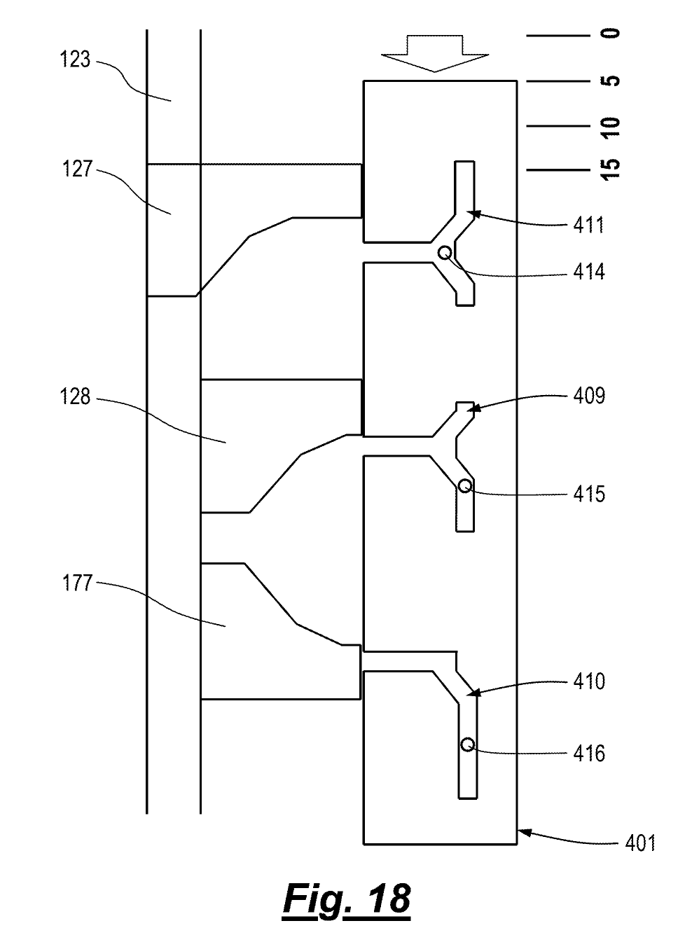

Referring to FIG. 18, the cam ring 401 is shown in a second rotational position. In this rotational position the cam ring 401 has been rotated in the anti-clockwise direction, when viewed looking from left to right in FIG. 16, from its first rotational position.

In this rotational position, the vanes 127, 128, 177 of the vane rings 134, 135, 171 are disposed in a second configuration. In the second configuration, the first vane ring 134 in the first position and the second and third vane rings 135, 176 are in the second position.

In its second rotational position, the protrusion 414 of the first vane ring 135 is located in the second section 411b of the first slot 411. As stated above, the second section 411b is located axially inboard of the third section 411c. Accordingly, as the cam ring 401 moves from its first rotational position to its second rotational position, the protrusion 414 is moved axially inboard. This moves the first vane ring 134, and therefore its vanes 127, axially inboard, to the first position, such that the vanes 127 extend substantially across the width of the diffuser passage 123. In this regard, the axially outboard ends of the vanes 127 abut the second surface 183 of the diffuser passage 123.

When the cam ring 401 is in its second rotational position, the protrusion 415 of the second vane ring 135 is located in the third section 409c of the second slot 409, at a second end of the third section 409c. In this regard, the second end of the third section 409c is an opposite end of the third section 409c to the first end. Similarly, the protrusion 416 of the third vane ring 171 is located in the second section 410b of the third slot 410, disposed between the first end of the second section 410b and a second end of the second section 410b. When the protrusions 415, 416 are located in these sections of the slots, the second and third vane rings 135, 171 are located in the second position, such that their vanes 128, 177 are disposed axially outboard of the diffuser passage 123 (as when the cam ring 401 is in its first rotational position).

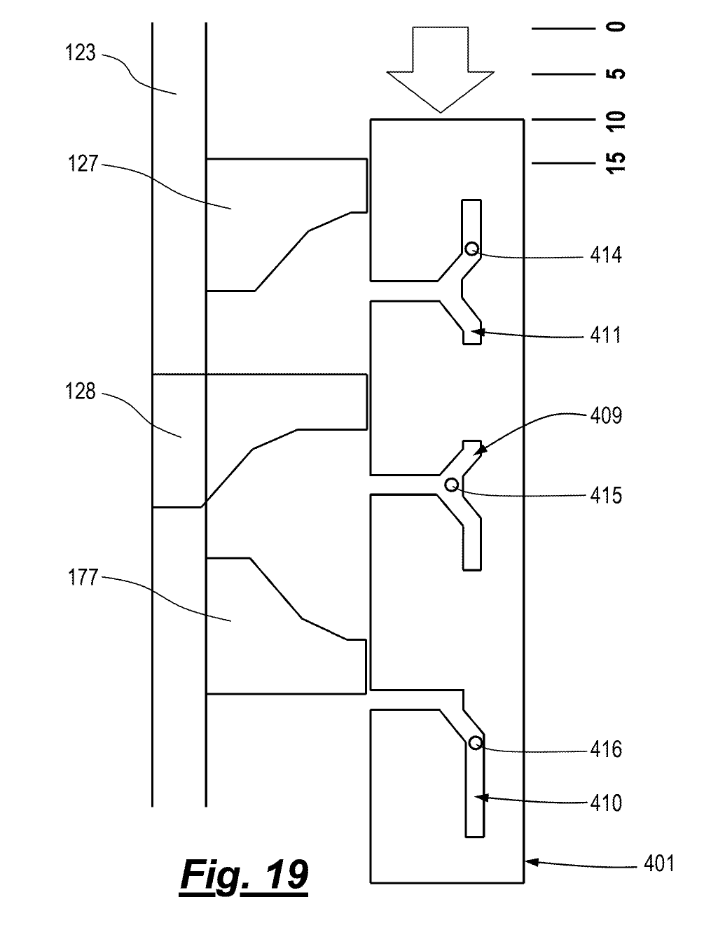

Referring to FIG. 19, the cam ring 401 is shown in a third rotational position. In the third rotational position, the cam ring 401 has been rotated in the anti-clockwise direction (when viewed looking from left to right in FIG. 16), from its second rotational position. When the cam ring 401 is in the third rotational position, the vane rings 134, 135, 176 are located in a third configuration. In the third configuration, the first and third vane rings 134, 176 are located in the second position and the second vane ring 135 is located in the first position.

In this regard, when the cam ring 401 is in its third rotational position, the protrusion 414 of the first vane ring 134 is located in the first section 411a of the first slot 411, at a first end of the first section 411a. This acts to move the first vane ring 134, from the first position to the second position.

The protrusion 415 of the second vane ring 135 is located in the second section 409b of the second slot 409 which, as stated above, is located axially inboard of the first and third sections 409a, 409c of the second slot 409. Accordingly, as the cam ring 401 is rotated from its second rotational position to its third rotational position, the protrusion 415 of the second cam ring 135 is moved axially inboard. This acts to move the second vane ring 135 axially inboard from the second position to the first position.

The protrusion 416 of the third vane ring 171 is located in the second section 410b of the first slot 410, at the second end of the second section 410b. Accordingly, as in the first and second rotational positions, the third vane ring 171 is located in the second position.

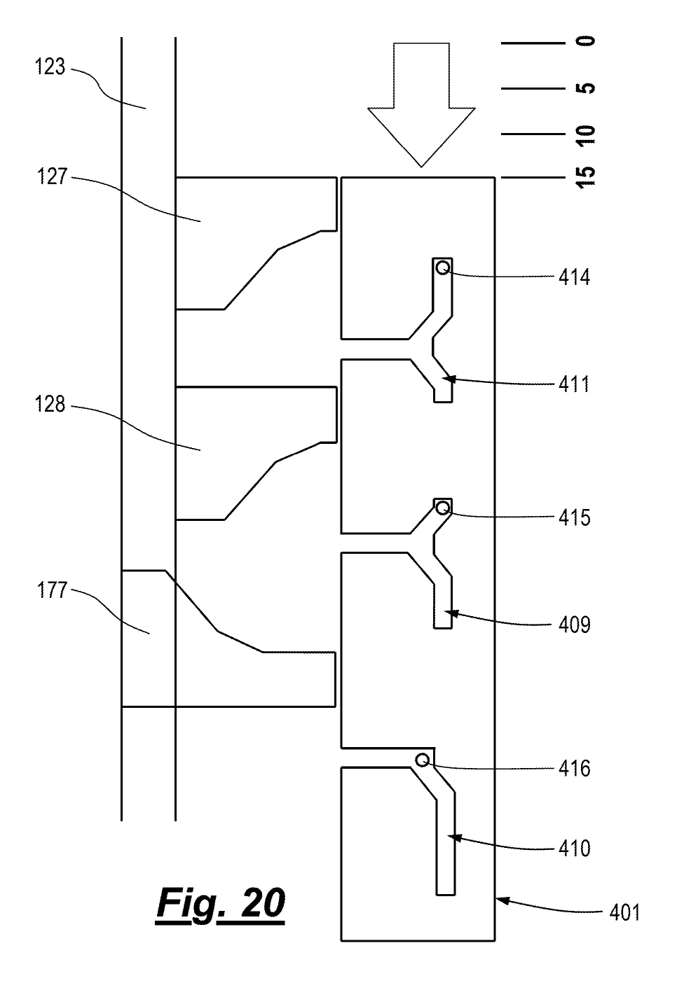

Referring to FIG. 20, the cam ring 401 is shown in a fourth rotational position. In this rotational position, the cam ring 401 has been rotated anti-clockwise (when viewed from left to right in FIG. 16) from its third rotational position. In this rotational position, the vane rings 134, 135, 176 are located in a fourth configuration. In this configuration, the first and second vane rings 134, 135 are located in the second position and the third vane ring 176 is located in the first position.

In this regard, when the cam ring 401 is in its fourth rotational position, the protrusion 414 of the first vane ring 134 is located in the first section 411a of the first slot 411, at a second end of the first section 411a. Accordingly, as in the third rotational position, the first vane ring 134 is located in the second position.

The protrusion 415 of the second vane ring 135 has now been moved from the second section 409b (when the cam ring 401 is in the third rotational position) to the first section 409a of the second slot 409. This moves the protrusion 415 axially outboard, which moves the second vane ring 135 axially outboard to the second position.

The protrusion 416 of the third vane ring 176 is now located in the first section 410a of the first slot 410. The first section 410a is located axially inboard of the second section 410b of the third slot 410. Accordingly, as the cam ring 401 moves from the third rotational position to its fourth rotational position, the protrusion 416 moves in the axially inboard direction. This moves the third vane ring 176 axially inboard to the first position.

As with the preceding embodiments, moving the vane rings 134, 135, 176 between said different configurations allows the operating point at which the efficiency gain is achieved to be varied. This therefore allows an efficiency gain to be provided at different operating points of the impeller wheel 6.

In addition, as with the preceding embodiments, the actuator assembly 501 is controlled by an engine control unit (not shown). The engine control unit is arranged to move the vane rings in dependence on a certain operating condition of the compressor (e.g. speed of the impeller wheel 6) so as to provide an efficiency gain at that operating condition.

Numerous modifications and variations may be made to the exemplary design described above without departing from the scope of the disclosure as defined in the claims.

For example, in the described embodiments the vane rings are mounted on the same side of the diffuser passageway 123, 223, i.e. on the bearing housing 3 side. Alternatively, one or more of the vane rings may be mounted on different axial sides of the diffuser passage.

Where vane rings are mounted on opposite sides of the diffuser passageway 123, 223, they may be arranged to move axially with each other, i.e. they may be axially fixed relative to each other.

In the described embodiments, the vane rings are coupled to a single actuator. Alternatively, different vane rings may be coupled to different actuators.

The described embodiments include where there are two or three vane rings. Alternatively, there may be additional vane rings, for example four or more vane rings, each vane ring being movable between said first and second positions.

It will be appreciated that each of the embodiments may be modified such that the vane rings may be moved to any other possible configuration, i.e. any other possible combination of first and second positions of the vanes. For example, the vane rings may be movable to a configuration in which they are all in the first position, or all in the second position, or any combination of first and second positions.

In the described embodiments, the first and second surfaces 181, 183 that define the diffuser passage 123 are substantially parallel to the radial direction. However, it will be appreciated that said first and second surfaces 181, 183 may be inclined relative to the radial direction.

In the described embodiments, each vane ring is provided with a respective said protrusion that is engaged by a respective protrusion of the cam member/ring to move the vane ring between the first and second positions. It will be appreciated that one or more of the vane rings may instead be otherwise coupled to a protrusion, or other cam surface, that is engaged by a respective protrusion of the cam member/ring to move the vane ring between the first and second positions.

In the described embodiments the compressor 40, 140, 240 is used as part of a turbocharger. However, the compressor is not limited to use as part of a turbocharger and may be used in different applications.

1. A compressor comprising:
a housing having an axial intake defining an intake passage and an annular outlet volute defining an outlet volute passage;
an impeller mounted on a shaft for rotation about a shaft axis between the axial intake and the outlet volute;
the impeller having a plurality of blades;
a diffuser defining an annular diffuser passage surrounding the impeller;
said annular diffuser passage having a diffuser inlet downstream of said plurality of blades, the tips of the blades sweeping across said diffuser inlet during use, and a diffuser outlet communicating with the outlet volute passage;
the diffuser passage being defined by opposed first and second radially extending surfaces;
wherein the compressor further comprises at least two vane members, each vane member having at least one vane arranged to be receivable in the diffuser passage;
and wherein at least one actuator is coupled to the at least two vane members so as to move each vane member such that the axial length of it's at least one vane within the diffuser passage is varied.

2. A compressor according to claim 1 wherein each vane member is movable relative to the diffuser passage between a first position and a second position, wherein when the vane member is in the first position, at least an axial length of it's at least one vane is located within the diffuser passage and when the vane member is in the second position, it's at least one vane is not located within the diffuser passage.

3. A compressor according to claim 2 wherein when each vane member is in the first position, it's at least one vane extends substantially across the axial extent of the diffuser passage.

4. A compressor according to claim 2 wherein the at least one vane of each vane member extends axially from a root, at a surface of an annular wall of the vane member, to a tip and when the vane member is in the second position, the tip of its at least one vane is disposed axially outboard of the diffuser passage.

5. A compressor according to claim 2 wherein the at least one actuator is coupled to each vane member such that the vane members are movable to a configuration in which at least one vane member is in the first position and at least one vane member is in the second position.

6. A compressor according to claim 2 wherein the at least one actuator is coupled to each vane member such that the vane members are movable to a configuration in which all of the vane members are in the first position.

7. A compressor according to claim 2 wherein the at least one actuator is coupled to each vane member such that the vane members are movable to a configuration in which all of the vane members are in the second position.

9-30. (canceled)

31. A compressor according to claim 1 wherein first and second of said vane members are mounted on the same axial side of the diffuser passage.

32. A compressor according to claim 1 wherein one or more of the vane members comprises a plurality of vanes.

33. A compressor according to claim 1 wherein the first and second radially extending surfaces of the diffuser passage are defined by a radially extending surface of a first and second wall member respectively, wherein at least one of the vane members is slidably mounted in a cavity on an axially outboard side of the first or second wall member, said first or second wall member being provided with at least one vane slot arranged such that as the at least one vane member is moved in the axial direction, it's at least one vane is receivable in the diffuser passage, through the at least one vane slot.

34. A compressor according to claim 1 wherein the at least one actuator is coupled to first and second of said vane members such that the first and second vane members are moved axially relative to each other.

35. A compressor according to claim 34 wherein the vanes of the first and second vane members are circumferentially spaced such that when the first and second vane members are moved axially relative to each other, their vanes pass each other in the axial direction.

36. A compressor according to claim 34 wherein one of the first and second vane members is provided with at least one slot to receive the at least one vane of the other of the first and second vane members, so as to allow relative axial movement between the vane members.

37. A compressor according to claim 34 wherein the first and second vane members are each be provided with a plurality of radially extending webs, wherein each vane of the vane member is mounted on a respective web and wherein the webs and vanes of each vane member are arranged such that when the vane members move axially relative to each other, the radially extending webs and vanes of one of the vane members are received between the radially extending webs and vanes of the other vane member so as to allow for relative axial movement between the vane members.

38. A compressor according to claim 1 wherein the at least one vane of each vane member is rotationally fixed relative to the shaft axis.

39. A compressor according to claim 1 wherein the at least one actuator is coupled to the at least two vane members by a cam member, the at least one actuator being arranged to move the cam member relative to the vane members, said cam member comprising at least two cam surfaces, wherein each vane member is provided with, or coupled to, a respective vane member cam surface, said cam surfaces being arranged such that as the cam member is moved relative to the vane members, each of the at least two cam surfaces of the cam member engages a respective vane member cam surface such that the vane member is moved in the axial direction relative to the diffuser passage.

40. A compressor according to claim 39 wherein the at least two cam surfaces are surfaces of respective protrusions on the cam member and wherein the vane member cam surfaces are surfaces of protrusions on the vane members.

41. A compressor according to claim 39 wherein the at least two cam surfaces are each a surface of a respective slot, wherein each vane member cam surface is received within a respective slot and as the cam member is moved relative to the vane members, each vane member cam surface travels along the respective slot, relative to the slot and wherein the cam surface of the respective slot engages the vane member cam surface such that the vane member is moved in the axial direction relative to the diffuser passage.

42. A compressor according to claim 41 wherein the cam member is an annular member, said slots being provided in the annular member.

43. A compressor according to claim 42 wherein the actuator is arranged to rotate the annular member relative to the vane members.

44. A turbocharger comprising a compressor according to claim 1.

45. An internal combustion engine comprising a turbocharger according to claim 44.

46. An internal combustion engine according to claim 45 comprising an engine control unit that is arranged to control the axial position of the at least two vane members.

47. An internal combustion engine according to claim 46 wherein the engine control unit is arranged to control the axial position of the at least two vane members in dependence on an operating condition of the compressor or turbocharger.

48. A method of use of a compressor, said compressor comprising:
a housing having an axial intake defining an intake passage and an annular outlet volute defining an outlet volute passage;
an impeller mounted on a shaft for rotation about a shaft axis between the axial intake and the outlet volute;
the impeller having a plurality of blades;
a diffuser defining an annular diffuser passage surrounding the impeller;
said annular diffuser passage having a diffuser inlet downstream of said plurality of blades, the tips of the blades sweeping across said diffuser inlet during use, and a diffuser outlet communicating with the outlet volute passage;
the diffuser passage being defined by opposed first and second radially extending surfaces;
the compressor comprising at least two vane members, each vane member having at least one vane arranged to be receivable in the diffuser passage;
and at least one actuator coupled to the at least two vane members so as to move each vane member in the axial direction;
wherein the method comprises using the at least one actuator to move each vane member such that the axial length of it's at least one vane within the diffuser passage is varied.
